(19) United States
(12) Patent Application Publication
(10) Pub. No.: US 2011/0321106 A1
(43) Pub. Date: Dec. 29, 2011

(54) TRANSMITTER, RECEIVER, COMMUNICATION EQUIPMENT, COMMUNICATION SYSTEM, TRANSMISSION METHOD AND RECEPTION METHOD

(76) Inventors: Sachio Takahashi, Iwate (JP); Kazuo Fuda, Iwate (JP)

(21) Appl. No.: 12/998,929

(22) PCT Filed: Dec. 22, 2009
(86) PCT No.: PCT/JP2009/007135

§ 371 Date: Sep. 6, 2011

(30) Foreign Application Priority Data
Dec. 24, 2008 (JP) 2008-328191

(51) Int. Cl. H04L 27/00; H04N 7/173; H04B 1/38

(52) U.S. Cl. 725/109; 375/295; 375/316; 375/219; 375/259

(57) ABSTRACT

To reduce the time required for communication of a video image data, as well as to prevent deterioration of image quality caused by compression and decompression. A clock control means 20 which outputs a plurality of clocks which have different frequencies; a division means 510 which divides analogue data into a prescribed number; a clock attachment means (transmission block processing part 520) which attaches a clock of a different frequency to each of the divided analogue data; a digital converting means (A/D conversion part 530) which converts the analogue data to digital data, thereby to generate a plurality of digital signals; and a transmission means (transmission part 710) which transmits to the outside the plurality of digital signals as transmission signals are provided.

### TECHNICAL FIELD

The present invention relates to a transmitter which transmits signals by radio or cable, a receiver which receives signals by radio or cable, a communication apparatus provided with a transmitting function and a receiving function, a communication system provided with the transmitter or the like, a transmission method showing the procedure of a signal transmitting process, and a receiving method showing the procedure of a signal receiving process. In particular, the present invention relates to a transmitter, a receiver, a communication apparatus, a communications system, a transmitting method, and a receiving method which transmits and receives a video image, an image, voice, data, and the like.

### BACKGROUND ART

In recent years, a mobile phone has come to be provided with many functions in order to meet diversified needs.

For example, a mobile phone has a telephone-call function, an e-mail function, a camera function, an internet access function, an electronic money function, etc. as standard or optional features. Further, in recent years, a mobile phone has come to be able to receive ground digital broadcast TV signals.

As mentioned above, a mobile phone has come to be diversified in function, and the performance thereof has been improving.

Further, with the diversification in function, the amount of data which is transmitted or received by a mobile phone has been further increasing. In particular, in ground digital broadcasting, teletext broadcasting is conducted which distributes information in the form of characters, in addition to voice or vide images. Moreover, in the case of high-definition television broadcasting with a high image quality, since it has more than twice as many scanning lines as compared with the NTSC (National Television System Committee) standard television broadcasting, the amount of information is large.

Further, a mobile phone provided with a TV phone function has been proposed (see Patent Document 1, for example).

According to this mobile phone, more advanced communication can be attained by effectively utilizing a display having a higher resolution than ever.
Patent Document 1: JP-A-2008-48062

### DISCLOSURE OF THE INVENTION

### Problems to be Solved by the Invention

However, in the technology disclosed in Patent Document 1 mentioned above, when TV phone calling is conducted, a video image data is transmitted after compression and the thus compressed video image data is decompressed. These compression and decompression processes are aimed at decreasing the amount of data while keeping the quality of the original image, and are time-consuming due to the need of complicated computing operation.

However, when watching TV broadcasting or using a TV phone calling function, if a transmitter sends a video image, a receiver has to receive this image and display it on the screen on the real time basis. However, if the amount of data of a video image is further increased, compression takes a longer period of time, and hence, a time lag may arise during a period of time from the acquisition of the video image by a transmitter to the display of the video image by a receiver. As a result, a receiver cannot display the video image on real time, and hence, a mobile phone cannot fully exhibit the functions such as TV broadcasting.

MPEG or the like are known as video image compression standards. However, since these standards are irreversible, if compression is once conducted, it is impossible to restore the compressed data to an uncompressed form completely. Therefore, if video image data which has been compressed is decomposed and displayed on the screen by a receiver, coarseness of the image becomes conspicuous. In particular, if a display has a higher resolution, significant deterioration of image quality becomes more noticeable. Under such circumstances, increasing the resolution poses a less important meaning.

The present invention has been made in view of the above-mentioned circumstances, and an object thereof is to provide a transmitter, a receiver, a communication apparatus, a communication system, a transmission method and a receiving method which realizes transmitting and receiving of a video image data of which the amount is large, and enables a receiver to receive a video image data on real time and to display the video image with a high image quality without deterioration of image quality.

### Means for Solving the Problems

In order to attain the above-mentioned problems, the present invention the present invention provides a transmitter comprising:

a clock control means which outputs a plurality of clocks which have different frequencies;

a division means which divides analogue data into a prescribed number;

a clock attachment means which attaches a clock of a different frequency to each of the divided analogue data;

a digital converting means which converts the analogue data to digital data, thereby to generate a plurality of digital signals; and

a transmission means which transmits to the outside the plurality of digital signals as transmission signals.

Further, the present invention provides a receiver comprising:

a receiving means which receives signals from the outside;

a splitter which splits the signals into a plurality of digital signals;

an analogue converting means which converts the plurality of digital signals to analogue signals and separates the signals into a plurality of analogue data and clocks; and

a synthesizing means which synthesizes the plurality of analogue data according to the frequency of the clock.

The present invention provides a communication apparatus comprising:

a clock control means which outputs a plurality of clocks which have different frequencies;

a division means which divides analogue data into a prescribed number;

a clock attachment means which attaches a clock of a different frequency to each of the divided analogue data;

a digital converting means which converts the analogue data to which the clock has been attached to digital data, thereby to generate a plurality of digital signals;

a transmission means which transmits to the outside the plurality of digital signals as transmission signals;

a receiving means which receives signals from the outside;

a splitter which splits the signals into a plurality of digital signals;

an analogue converting means which converts the plurality of digital signals to analogue signals to separate the signals into a plurality of analogue data and clocks; and

a synthesizing means which synthesizes the plurality of analogue data according to the frequency of the clock.

The present invention also provides a communication system comprising one or two or more transmitters and one or two or more receivers, wherein the transmitters comprise the transmitter according to any one of claims 1 to 8, and the receivers comprise the receiver according to claim 9 or 10.

The present invention provides a communication system which comprises a plurality of communication apparatuses and a base station which relays signals which are transmitted and received between the communication apparatuses.

The present invention provides a communication system which comprises a web tuner which receives video image communication signals which have been transmitted from a video image distribution apparatus through a communication line and outputs video image signals, and a display apparatus which displays a video image based on the video image signals, wherein the web tuner comprises the communication apparatus according to claim 13.

The present invention provides a communication system comprising:

a camera apparatus which takes an image of an object to be photographed;

a first web tuner which receives picked-up image signals based on the image taken by the camera apparatus;

a video image distribution apparatus which receives the picked-up image signals from the first web tuner and transmits the signals to a second web tuner through a communication line; and

a display apparatus which inputs the picked-up image signals through the second web tuner and displays a video image based on the picked-up image signal, wherein

the first and/or the second web tuner comprises the communication apparatus according to claim 13.

The present invention provides a transmission method comprising:

outputting a plurality of clocks which have different frequencies;

dividing analogue data into a prescribed number;

attaching a clock of a different frequency to each of the divided analogue data;

converting the analogue data to which the clock has been attached to digital data, thereby to generate a plurality of digital signals; and

transmitting the plurality of digital signals to the outside as transmission signals.

The present invention provides a receiving method comprising:

receiving signals from the outside;

splitting the signals into a plurality of digital signals;

converting the plurality of digital signals to analogue signals and dividing the signals into a plurality of analogue data and clocks; and

synthesizing the plurality of analogue data based on the frequency of the clock.

### Advantageous Effects of the Invention

According to the transmitter, the receiver, the communication apparatus, the communication system, the transmission method and the receiving method of the present invention, since video image data as analogue data is divided into a prescribed number, a clock of different frequency is attached to each of the divided data, and the divided analogue data is then converted to digital data, and the digital data is transmitted to the outside, the divided data can be transmitted within the width of carrier of a communication line. Therefore, transmitting and receiving of video image data of which the data amount is large can be possible without conducting compression and decompression.

Further, since no compression or decompression is required, the time required for communication can be shortened, and acquired video data can be received and displayed on the real time basis. Further, since compression is not necessary, deterioration of an image quality due to decompression can be prevented; whereby an image can be displayed with a high image quality.

### BRIEF DESCRIPTION OF THE DRAWINGS

FIG. 1 is a block diagram showing the configuration of the communication apparatus according to the first embodiment of the present invention;

FIG. 2 is a block diagram showing the detailed configuration of the communication apparatus;

FIG. 3 is a view showing the manner of dividing an image into a plurality of regions;

FIG. 4 is a block diagram showing the configurations of the transmission block processing part and the ND conversion part;

FIG. 5 is a view showing the manner in which the divided data is subjected to blocking and ND conversion, in which (i) is a view showing the manner in which the block data is put in the signal frame and a clock is attached; and (ii) is a view showing the manner in which the analogue transmission signals comprising block data and clocks is converted to a digital signal;

FIG. 6 is a view showing the signal frame which has been set for each stage and a clock which has been attached thereto;

FIG. 7 is a view the showing the signal frame of each stage being arranged on the frequency axis;

FIG. 8 is a view showing a plurality of digital signals being mixed;

FIG. 9 is a view showing voice data which has been modulated by FM carrier;

FIG. 10 is a block diagram showing the configurations of the D/A conversion part and the receiving block processing part;

FIG. 11 is a block diagram showing the configuration of the transmission part;

FIG. 12 is a block diagram showing the configuration of the receiving part;

FIG. 13 is a flow chart showing the procedure of the transmission method of the communication method according to the first embodiment of the present invention;

FIG. 14 is a flow chart showing the procedure of the receiving method of the communication method according to the first embodiment of the present invention;

FIG. 15 is a view explaining the effects brought about by using the communication apparatus of the present invention;

FIG. 16 is a block diagram showing the configuration of the communication apparatus according to the second embodiment of the present invention;

FIG. 17 is a block diagram showing the configuration of the communication control means;

FIG. 18 is a flow chart showing the transmission operation of the communication apparatus according to the second embodiment of the present invention;

FIG. 19 is a flow chart showing the receiving operation of the communication apparatus according to the second embodiment of the present invention;

FIG. 20 is a block diagram showing the configuration of the web tuner according to the first embodiment of the present invention;

FIG. 21 is a schematic diagram showing the first image transmission system;

FIG. 22 is a schematic diagram showing the second image transmission system;

FIG. 23 is a schematic diagram showing the third image transmission system;

FIG. 24 is a schematic diagram showing the fourth image transmission system;

FIG. 25 is a flow chart showing, of the operations of the web tuner according to the first embodiment of the present invention, the operation of transmission;

FIG. 26 is a flow chart showing, of the operations of the web tuner according to the first embodiment of the present invention, the operation of the receiving;

FIG. 27 is a block diagram showing the configuration of the web tuner according to the second embodiment of the present invention;

FIG. 28 is a view showing an object to be photographed which is divided by a plurality of corner segments;

FIG. 29 is a block diagram showing another configuration of the web tuner according to the second embodiment of the present invention;

FIG. 30 is a block diagram showing the configuration of the transmitter;

FIG. 31 is a block diagram showing the detailed configuration of the transmitter;

FIG. 32 is a block diagram showing the configuration of the receiver;

FIG. 33 is a block diagram showing the detailed configuration of the receiver;

FIG. 34 is a schematic view showing the configuration of the communication system according to the first embodiment of the present invention;

FIG. 35 is a schematic view showing another configuration of the communication system according to the first embodiment of the present invention;

FIG. 36 is a schematic view showing the configuration of the communication system according to the second embodiment of the present invention; and

FIG. 37 is a view showing eight signal frames arranged on the frequency axis.

### EXPLANATION OF NUMERICAL SYMBOLS

1 (1a to 1d) Communication apparatus
10 Crystal oscillator
20 Clock control means
40 Display means
50 Signal processing means
510 Division part (division means)
520 Transmission block processing part (clock attachment means)
530 A/D conversion part (digital conversion means)
540 D/A conversion part
550 Receiving block processing part
560 Synthesizing part (synthesizing means)
60 Data control means
620 Mixer
630 Splitter
70 Transmitting and receiving means
710 Transmitting part (transmitting means)
720 Receiving part
90 Communication control means
2 (2a to 2c) Web tuner
9 (9a to 9c) Communication system
1s1 Communication apparatus (transmission side)
1r1, 1r2 Communication apparatus (receiving side)
110 Transmitter
120 Receiver

### BEST MODE FOR CARRYING OUT THE INVENTION

Hereinbelow, preferred embodiments of the transmitter, the receiver, the communication apparatus, the communication system, the transmission method and the receiving method according to the present invention will be explained with reference to the drawings.

### First Embodiment of the Communication Apparatus and the Communication Method

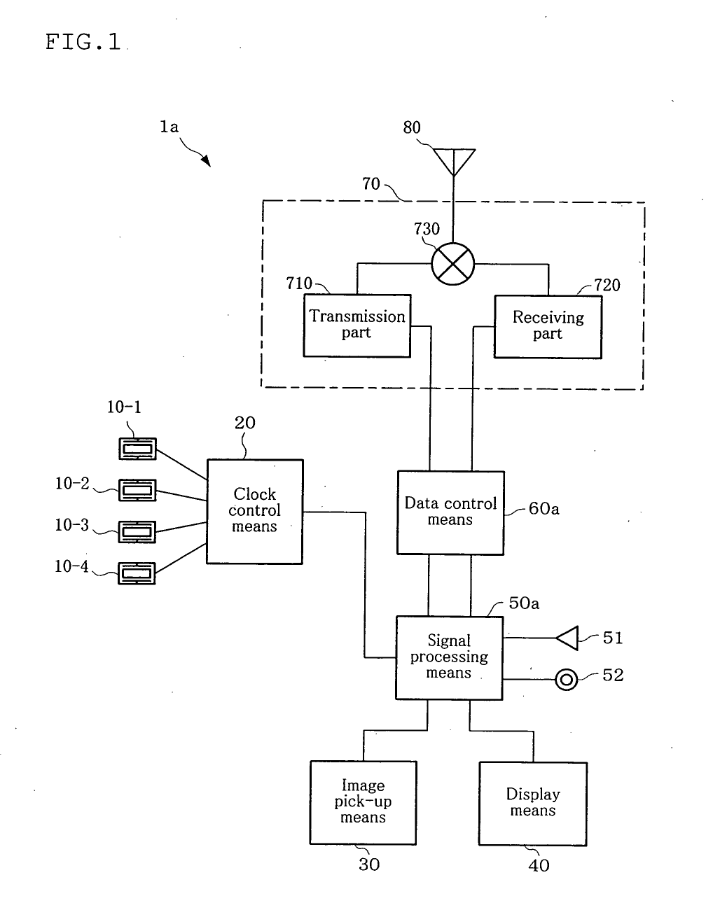

At first, the first embodiment of the communication apparatus and the communication method according to the present invention will be explained with reference to FIG. 1.

FIG. 1 is a block diagram showing the configuration of the communication apparatus of this embodiment.

### (I) Communication Apparatus

As shown in FIG. 1, a communication apparatus 1a comprises crystal oscillators 10 (10-1 to 10-n), a clock control means 20, a image pick-up means 30, a display means 40, a signal processing means 50a, a data control means 60a, transmitting and receiving means 70 and an antenna 80.

Here, a plurality of crystal oscillators 10 (four, in this embodiment) are provided, and each of these oscillator outputs a clock of a different frequency. Further, each of the plurality of clocks can have a frequency which is integral multiple of a prescribed frequency (2.1 MHz in this embodiment).

Specifically, for example, the first crystal oscillator 10-1 outputs clock A having a frequency of 2.1 MHz, the second crystal oscillator 10-2 outputs clock B having a frequency of 4.2 MHz, the third crystal oscillator 10-3 outputs clock C having a frequency of 6.3 MHz and the fourth crystal oscillator 10-4 outputs clock D having a frequency of 8.4 MHz.

Although four crystal oscillators 10 are provided in this embodiment, the number of the crystal oscillators is not limited to four. An arbitral number of the crystal oscillators can be provided according to need.

The clock control means 20 sends a clock which has been output from the crystal oscillator 10 to the signal processing means 50a. At this time, the clock control means 20 can send all of the plurality of clocks which have been sent from the crystal oscillator 10 to the signal processing means 50a. Further, one or two or more clocks can be selected from the plurality of clocks and sent to the signal processing means 50a.

The number of clocks to be selected can be decided according to the kind of signals which are processed by the signal processing means 50a. For example, when the signal is image data, clocks are selected in a number corresponding to the number of divided data. Further, if the signal is voice data alone, only clock A is selected.

For example, the image pick-up means 30 can be composed of a CCD camera or the like, and it takes a still image or a moving image, and sends this picked-up image data (analogue data) to the signal processing means 50a.

The display means 40 can be composed of a liquid crystal display, or the like, and it displays a still image, a moving image, characters or the like which have been sent from the signal processing means 50a.

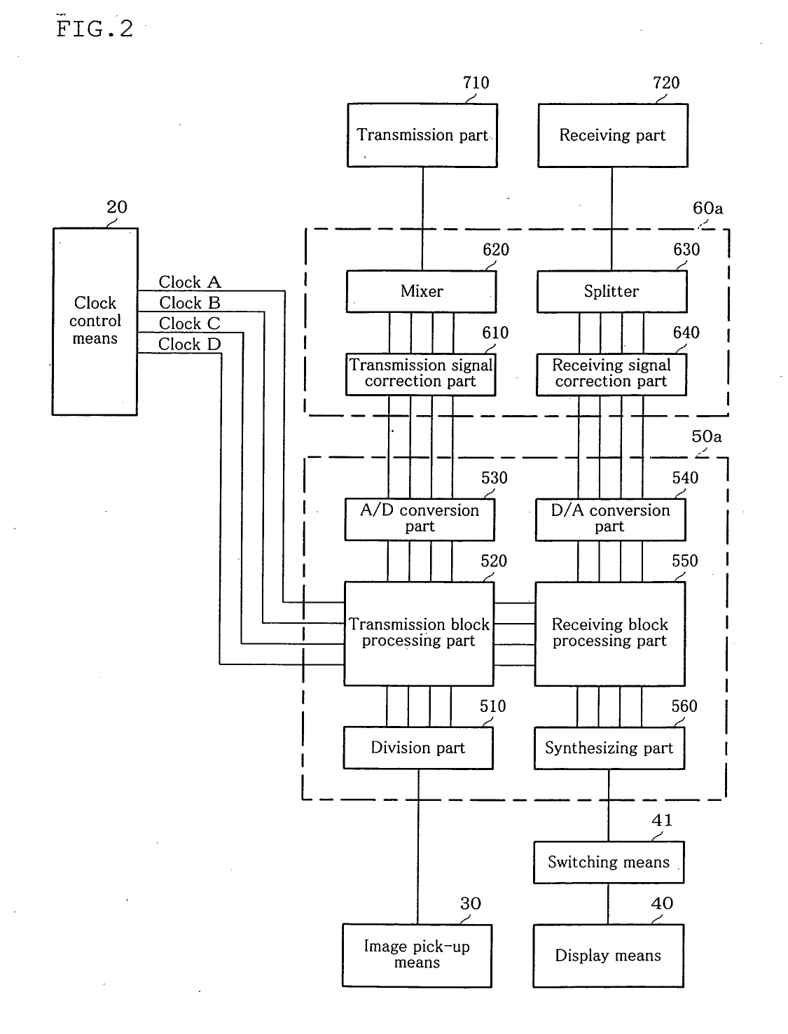

Between the display means 40 and the signal processing means 50a, as shown in FIG. 2, a switching means 41 can be provided. The switching means 41 switches information displayed on the display means 40. For example, it switches an image and data.

The signal processing means 50a converts the picked-up image data (analogue data) which has been sent from the image pick-up means 30 to digital signals and sends the digital signals to a data control means 60a. The signal processing means 50a sends voice data which has been sent from a microphone 52 to the data control means 60a.

Further, the signal processing means 50a converts digital signals which have been sent from the data control means 60a to analogue data, and sends picked-up image data and voice data to the display means 40 and a loud speaker 51, respectively.

As shown in FIG. 2, this signal processing means 50a is provided with a division part 510, a transmission block processing part 520, an A/D conversion part 530, a D/A conversion part 540, a receiving block processing part 550 and a synthesizing part 560.

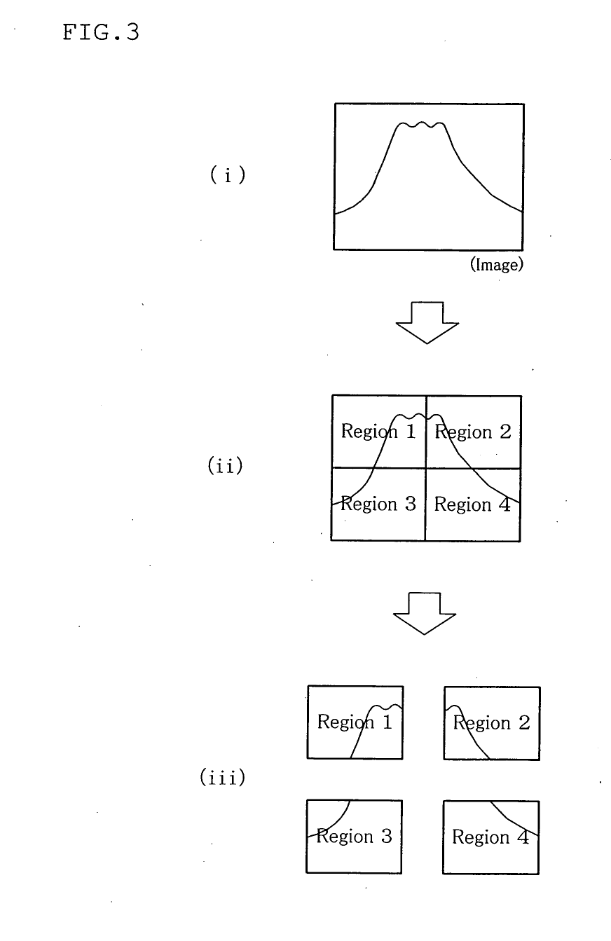

The division part (division means) 510 divides picked-up image data which has been sent from the image pick-up means 30 into a prescribed number. In this division processing, as shown in FIG. 3, the picked-up image data is divided in correspondence with each region which is formed when one image generated by the analogue data is divided into a plurality of regions (four regions 1 to 4, in this embodiment).

The transmission block processing part 520 blocks the divided data (blocking).

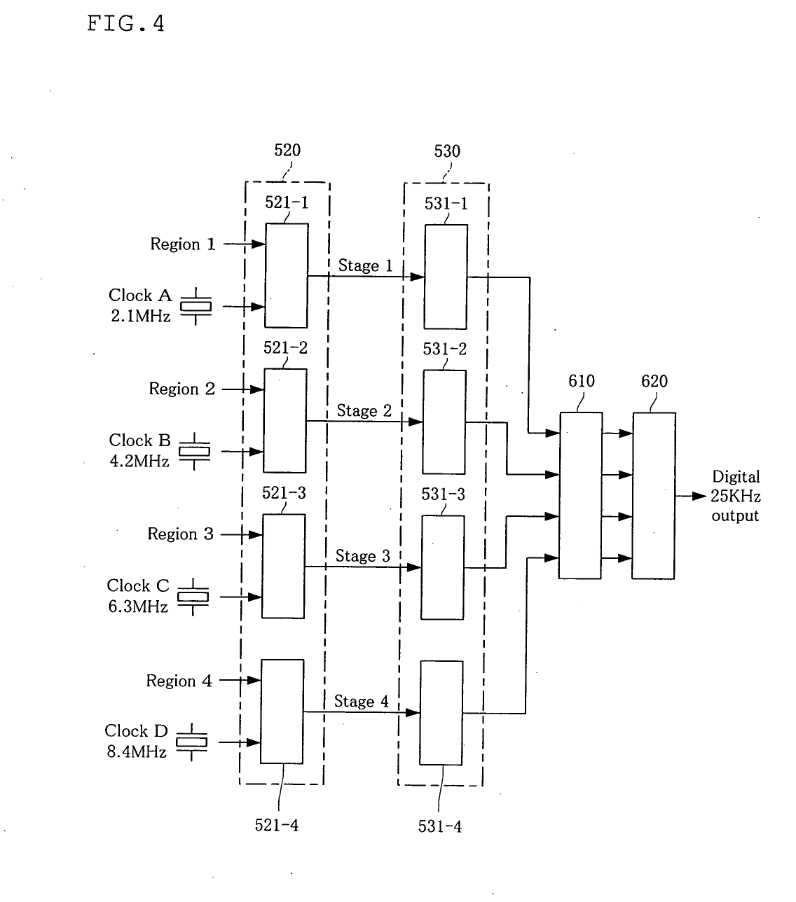

As shown in FIG. 4, this transmission block processing part 520 has a plurality of block generation parts 521 (521-1 to 521-n). Each of the block generation parts 521 receives one divided data, and the divided data is then blocked.

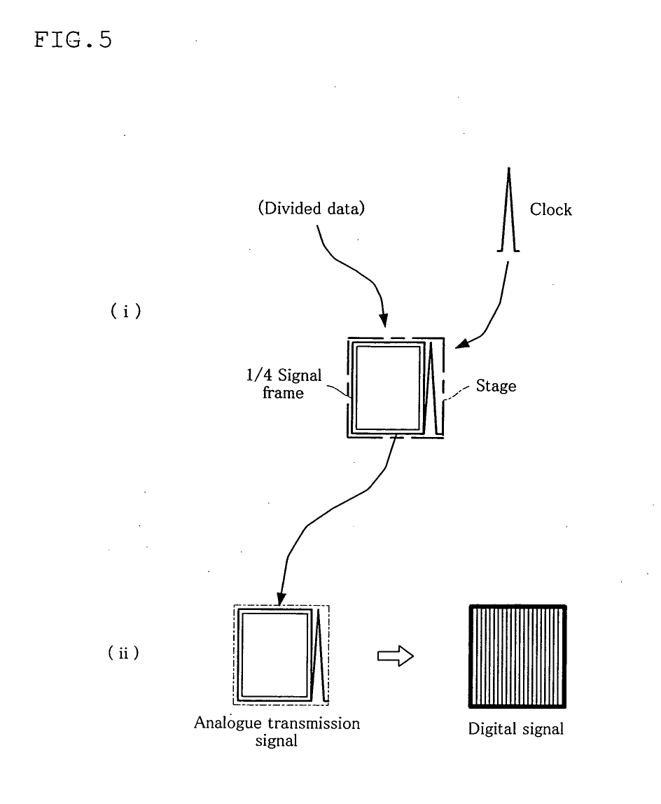

This blocking is conducted by the procedure as shown in FIG. 5(i).

First, the block generation part 521 receives divided data from the division part 510. For example, the first block generation part 521-1 receives the divided data of the region 1. The second block generation part 521-2 receives the divided data of region 2. The third block generation part 521-3 receives the divided data of region 3. The fourth block generation part 521-4 receives the divided data of region 4.

Subsequently, the block generation part 521 divides the divided data according to a prescribed data amount, thereby to generate block data. The amount of this block data is allowed to be an amount which can be put in the ¼ signal frame (hereinafter abbreviated as the “signal frame”) shown in FIG. 5 (i); 6.4 kbytes, for example. The signal frame can allow the modulation width (carrier width) to be 25 kHz, for example.

Then, the block generation part 521 puts block data in the signal frame prepared for the stage.

For example, the first block generation part 521-1 divides the divided data 1 of the region 1 by 64 kbytes, thereby to generate the block data 1, and puts it in the signal frame 1 of the stage 1. Further, the second block generation part 521-2 divides the divided data 2 of the region 2 by 64 kbytes, thereby to generate the block data 2, and puts it in the signal frame 2 of the stage 2. Furthermore, the third block generation part 521-3 divides the divided data 3 of the region 3 by 64 kbytes, thereby to generate the block data 3, and puts it in the signal frame 3 of the stage 3. The fourth block generation part 521-4 divides the divided data 4 of the region 4 by 64 kbytes, thereby to generate the block data 4, and puts it in the signal frame 4 of the stage 4.

The block generation part 521 receives a plurality of clocks from the clock control part 20.

The plurality of clocks has different frequencies, and each clock corresponds to each of a plurality of stages. For example, the clock A corresponds to the stage 1. The clock B corresponds to the stage 2. The clock C corresponds to the stage 3. The clock D corresponds to the stage 4.

Further, the frequency range of each stage is set according to the frequency of a clock. For example, the frequency range of the stage 1 is from 0 Hz to 2.1 MHz which is the frequency of the corresponding clock A. The frequency range of the stage 2 is from 0 Hz to 4.2 MHz which is the frequency of the corresponding clock B. The frequency range of the stage 3 is from 0 Hz to 6.3 MHz which is the frequency of the corresponding clock C. The frequency range of the stage 4 is from 0 Hz to 8.4 MHz which is the frequency of the corresponding clock D.

Then, the block generation part 521 attaches a corresponding clock (subcarrier) to the signal frame (block data) of each stage.

For example, the first block generation part 521-1 attaches the corresponding clock A to the signal frame 1 of the stage 1. Further, the second block generation part 521-2 attaches the corresponding clock B to the signal frame 2 of the stage 2. Further, the third block generation part 521-3 attaches the corresponding clock C to the signal frame 3 of the stage 3. The fourth block generation part 521-4 attaches the corresponding clock D to the signal frame 4 of the stage 4.

As a result, in the block generation part 521, a set of block data and clocks in each region (analogue transmission signal) is formed for each stage.

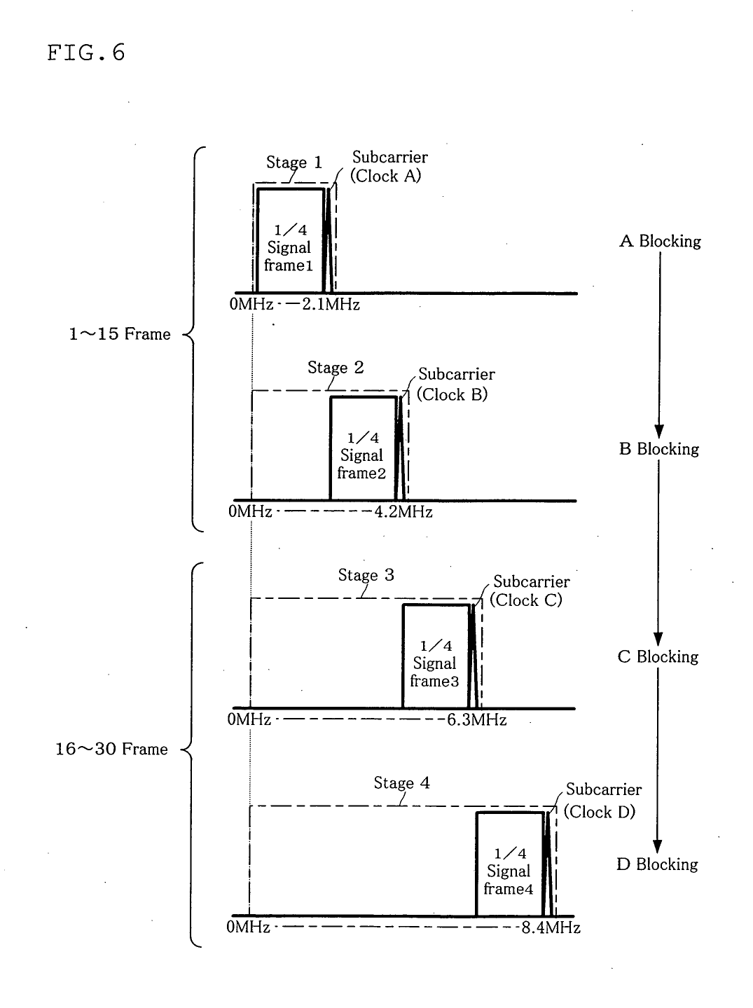

The manner of such formation is shown in FIG. 6. That is, in the stage 1, a set of the signal frame 1 in which the block data 1 of the region 1 is put and the clock A is formed. In the stage 2, a set of the signal frame 2 in which the block data 2 of the region 2 is put and the block B is formed. In the stage 3, a set of the signal frame 3 in which the block data 3 of the region 3 is put and the clock C is formed. In the stage 4, a set of the signal frame 4 in which the block data 4 of the region 4 is put and the clock D is formed.

Due to the above-mentioned processing, the data amount of the analogue transmission signals for each stage is equal to or smaller than the amount of data which can be transmitted by a transmission path (if the communication apparatus 1a of this embodiment is a mobile phone, the wireless transmission path between the mobile phone and a base station 300). That is, the amount of block data constituting an analogue transmission signal is the data amount which can be transmitted within the carrier width of the transmission path. As a result, picked-up image data can be transmitted and received without compression and decompression.

The stage 1 and the stage 2 can be in correspondence with 1 to 15 frames of a single screen of picked-up image data. The stage 3 and the stage 4 can be in correspondence with 16 to 30 frames of the single screen.

In the division of an image as shown in FIG. 3, if a horizontal line dividing the region 1 and the region 2 and the region 3 and the region 4 is taken as the standard line, the stage 3 and the stage 4 shown in FIG. 6 become a signal frame and a clock which are directed downward relative to the standard line. However, in this case, by conducting an HL conversion, it is possible to convert the waveform to the waveform shown in FIG. 6, i.e. a waveform which is directed upward relative to the standard line.

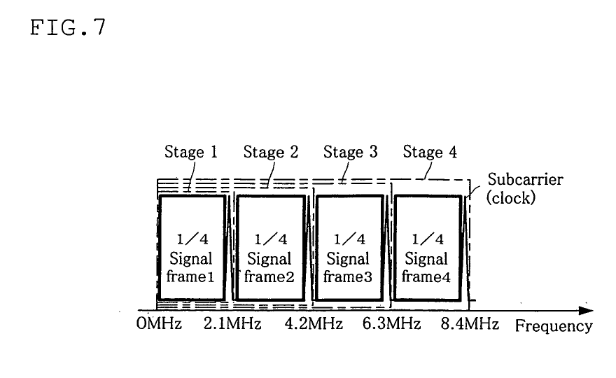

Further, each clock has a frequency which is different from each other, and is multiple integral of a prescribed frequency. In addition, as shown in FIG. 6, each stage has a frequency range from 0 MHz to the frequency of a clock. Therefore, if all stages are arranged on one frequency axis, as shown in FIG. 7, analogue transmission signals of each stage are arranged without being overlapped, and each signal frame is formed such that it is put between clocks.

Further, the transmission block processing part 520 and the block generation parts 521-1 to 521-n have a function as the “clock attachment means” since it attaches a clock to block data (analogue data after division).

The A/D conversion part (digital conversion means) 530 converts analogue transmission signals which are formed by the transmission block part 520 to digital signals.

As shown in FIG. 4, this A/D conversion part 530 has conversion signal generation part 531 (531-1 to 531-n) in a number which is at least equal to the divided number (four, in this embodiment) of the picked-up image data.

As shown in FIG. 5(ii), the conversion signal generation part 531 digitally encodes analogue transmission signals, thereby to obtain digital signals. That is, the conversion signal generation part 531 digitally encodes both the block data put in the signal frame and the frequency of the clock attached thereto, whereby digital signals are generated.

Specifically, for example, a first conversion signal generation part 531-1 digitally encodes both block data 1 put in the signal frame 1 of the stage 1 and the frequency of the clock A, thereby to generate digital signals 1. A second conversion signal generation part 531-2 digitally encodes both block data 2 put in the signal frame 2 of the stage 2 and the frequency of the clock B, thereby to generate digital signals 2. A third conversion signal generation part 531-3 digitally encodes both block data 3 put in the signal frame 3 of the stage 3 and the frequency of the clock C, thereby to generate digital signals 3. A fourth conversion signal generation part 531-4 digitally encodes both block data 4 stored in the signal frame 4 of the stage 4 and the frequency of the clock D, thereby to generate digital signals 4.

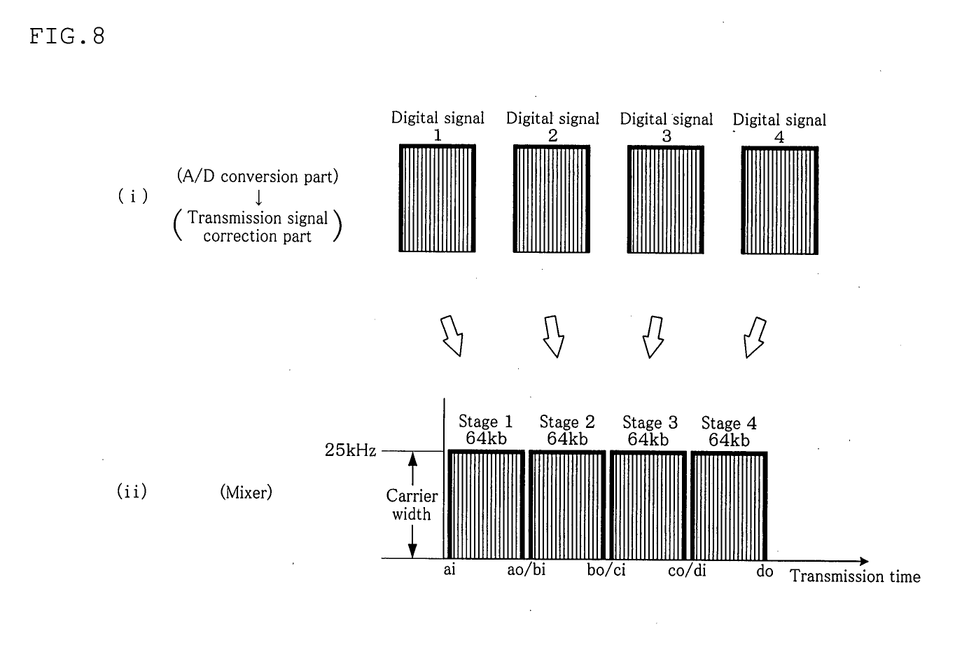

The digital signals for each stage generated by these conversion signal generation parts 531 are shown in FIG. 8(i). FIG. 8(i) is a view showing the digital signals 1 to 4 which are formed by the conversion signal generation part 531 and stored in a transmission signal correction part 610 (mentioned later).

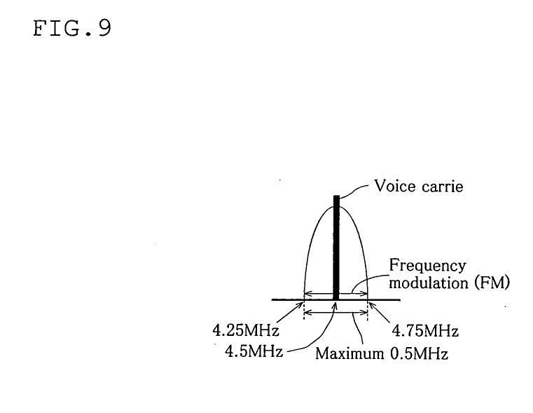

The signal processing means 50a, after receiving voice signals (analogue data) from the microphone 52, as shown in FIG. 9, it can modulate the voice signals with FM (Frequency Modulation) voice carrier with a frequency of 4.5 MHz and subject the signals to A/D conversion, and send to a data control means 60a. The voice signals are sent after frequency modulation between 4.25 MHz and 4.75 MHz (maximum 0.5 MHz).

A D/A conversion part (analogue conversion means) 540 takes the digital signals from a receiving signal correction part 640 (mentioned later) of the data control means 60a, and convert the signals to analogue transmission signals. Therefore, the digital signals shown in FIG. 5(ii) are converted to analogue transmission signals.

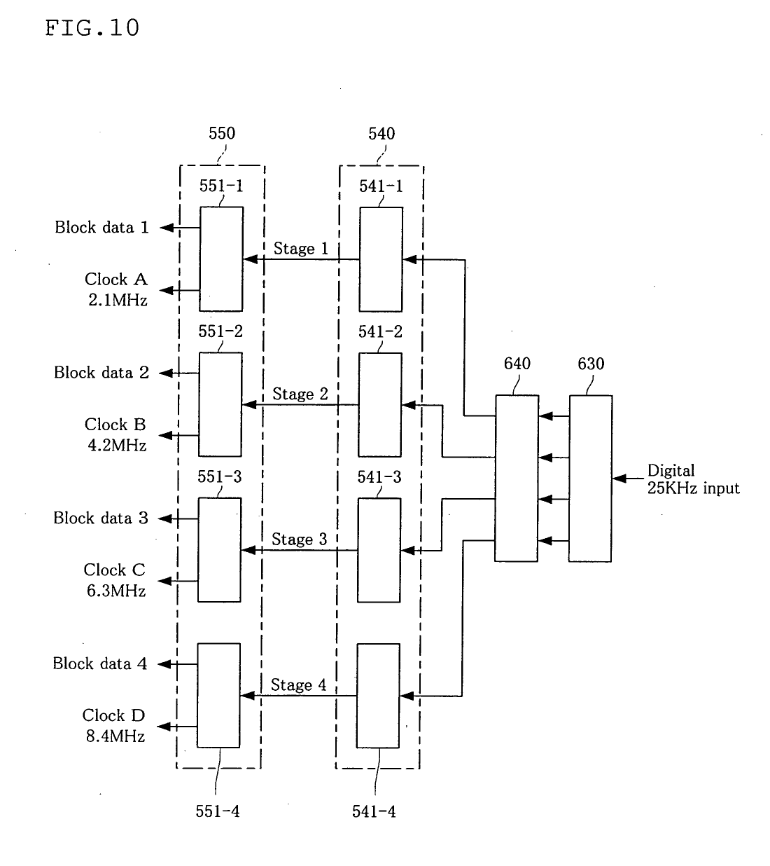

As shown in FIG. 10, this D/A conversion part 540 has a plurality of (four, in this embodiment) signal conversion parts 541 (541-1 to 541-n).

The signal conversion part 541 converts the digital signals which are digitally encoded (blocked) to analogue signals, thereby to obtain analogue transmission signals.

Specifically, for example, a first signal conversion part 541-1 converts the digital signals 1 to analogue signals, thereby to obtain the analogue transmission signals 1. Further, a second signal conversion part 541-2 converts the digital signals 2 to analogue signals, thereby to obtain the analogue transmission signals 2. Further, a third signal conversion part 541-3 converts the digital signals 3 to analogue signals, thereby to obtain the analogue transmission signals 3. A fourth signal conversion part 541-4 converts the digital signals 4 to analogue signals, thereby to obtain the analogue transmission signals 4.

The receiving block processing part 550 separates, from analogue transmission signals, a clock and block data put in the signal frame, and send them to the synthesizing part 560.

This receiving block processing part 550 has, as shown in FIG. 10, a plurality of (four, in this embodiment) block separation parts 551 (551-1 to 551-n).

The block separation part 551 receives one analogue transmission signal. The block separation part 551 separates the block data and the clock from this analogue transmission signal, specifies the frequency of the clock and sends it to a synthesizing part 560.

Specifically, for example, the first block separation part 551-1 receives the analogue transmission signals 1, and separates the signals into the block data 1 and the clock A. The second block separation part 551-2 receives the analogue transmission signals 2, and separates the signals into the block data 2 and the clock B. The third block separation part 551-3 receives the analogue transmission signals 3, and separates the signals into the block data 3 and the clock C. Further, the fourth block separation part 551-4 receives the analogue transmission signals 4, and separates the signals into the block data 4 and the clock D.

The first block separation part 551-1 compares the frequency of the clock separated from the analog transmission signals with the frequencies of clocks A to D which have been sent from the clock control means 20. As a result of the comparison, if the frequency of the clock separated from the analogue transmission signals agrees with the frequency of the clock A, it specifies the clock separated from the analog transmission signal as the clock A, and specifies the block data separated from the analog transmission signal as the block data 1.

Similarly, the second block separation part 551-2 compares the frequency of the clock separated from the analog transmission signals with the frequencies of clocks A to D which have been sent from the clock control means 20. As a result of the comparison, if the frequency of the clock separated from the analogue transmission signals agrees with the frequency of the clock B, it specifies the clock separated from the analog transmission signal as the clock B, and specifies the block data separated from the analog transmission signal as the block data 2. The same can be applied to the processing in the third block separation part 551-3 and the processing in the fourth block separation part 551-4.

Then, the block data 1 to 4 and the clocks A to D are sent to the synthesizing part 560.

The synthesizing part (synthesizing means) 560 synthesizes the plurality of block data 1 to 4 which have been sent from the receiving block processing part 550 according to the frequency of clocks A to D.

That is, the synthesizing part 560 judges the frequency of the clock, specifies the region of an image based on this frequency, and synthesizes block data according to the arrangement order of these regions.

For example, the synthesizing part 560 judges the block data 1 to which the clock A has been attached as the block data 1 of the region 1. The synthesizing part 560 judges the block data 2 to which the clock B has been attached as the block data 2 of the region 2. The synthesizing part 560 judges the block data 3 to which the clock C has been attached as the block data 3 of the region 3. The synthesizing part 560 judges the block data 4 to which the clock D has been attached as the block data 4 of the region 4.

Subsequently, the synthesizing part 560 synthesizes the block data 1 to 4 according to the arrangement order of the regions 1 to 4, thereby to form a single image. The thus formed image is sent to and displayed at the display means 40.

The arrangement order of the regions 1 to 4 is as shown in FIG. 3(ii). That is, the region 1 formed by the block data 1 is arranged at the upper left, the region 2 formed by the block data 2 is arranged at the upper right, the region 3 formed by the block data 3 is arranged at the lower left and the region 4 formed by the block data 4 is arranged at the lower right. Based on each block data, a single image is formed.

Meanwhile, if the block data is video image data, the synthesizing part 560 sequentially synthesizes block data which has been sent from the receiving block processing part 550, and sends the thus synthesized data to the display means 40. As a result, the display means 40 can display this video image.

If the data sent from the data control means 60a is voice data, the signal processing means 50a sends the voice data to the loud speaker 51 to allow it to be output to the outside. This voice data is digital signals when received by the antenna 80, and hence, is converted to analogue signals at the D/A conversion part 540.

The data control means 60a mixes digital signals which have been sent from the signal processing means 50a. Further, the data control means 60a splits demodulated signals which have been sent from the receiving part 720 (mentioned later) of the transmitting and receiving means 70.

As shown in FIG. 2, this data control means 60a is provided with a transmission signal correction part 610, a mixer 620, a splitter 630 and a receiving signal correction part 640.

A transmission signal correction part 610 stores and holds digital signals generated in the conversion signal generation part 531 of the ND conversion part 530 of the signal processing means 50a. The state where the digital signals are stored in this transmission signal correction part 610 is shown in FIG. 8(i). As mentioned above, the transmission signal correction part 610 has a function as the storage part.

Further, the transmission signal correction part 610 corrects the digital signals when storing the signals.

As shown in FIGS. 8(i) and (ii), a mixer 620 takes out the digital signals 1 to 4 of each stage from the transmission signal correction part 610 and mix them. The digital signals thus mixed are then sent to the transmission part 710 of transmitting and receiving means 70 as mixed signals.

If the data taken by the image pick-up means 30 is video image data, data which has been converted to digital signals by the ND conversion part 530 is sequentially stored in the transmission signal correction part 610. Here, a certain period of time is taken from the start of digital encoding of block signals of the stage 1 to the completion of digital encoding of block signals of the stage 4. The transmission signal conversion part 610 holds (chain) digital signals until digital encoding of each block signal of the four stages is completed. These are held with a time difference, and for example, 30 or 60 image frames are formed in one-in-four set.

When the digital signals of all regions (stage) in a single image is stored in the transmission signal correction part 610, the mixer 620 takes out these signals and mixed. While this mixer 620 conducts processing, the transmission signal correction part 610 sequentially stores digital signals which have been sent from the signal processing means 50a.

The splitter 630 splits demodulated signals which have been sent from the receiving part 720 into digital signals for each stage.

The receiving signal correction part 640 stores digital signals which have been split by the splitter 630.

The state where the digital signals are stored in this receiving signal correction part 640 is shown in FIG. 8(i). As mentioned above, the receiving signal correction part 640 has a function as the storage part.

Further, the receiving signal correction part 640 corrects digital signals when storing them.

The transmitting and receiving means 70 has a transmission part 710, a receiving part 720 and a mixer 730.

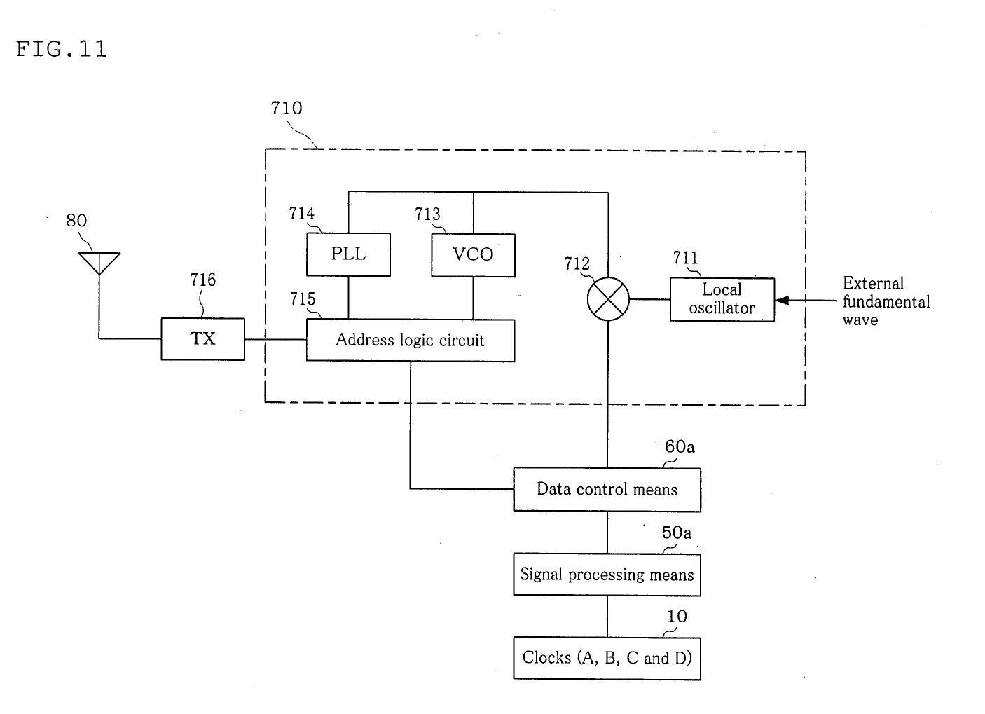

As shown in FIG. 11, the transmission part (transmission means) 710 has a local oscillator 711, a mixer 712, a VCO 713, a PLL 714, an address logic circuit 715 and a TX 716.

Upon receipt of a fundamental wave (for example, a carrier of 830 MHz) from the outside, the local oscillator (local OS) 711 sends it to the mixer 712.

The mixer (MIX) 712 modulates the carrier sent from the local oscillator 711 by mixed signals which have been sent from the data control means 60a, thereby to generate transmission signals.

A VCO (Voltage Controlled Oscillator) 713 controls the frequency of transmission signals from the mixer 712 according to the control voltage of the PLL 714.

A PLL (Phase Locked Loop) controls such that the frequency of the transmission signals output from the VCO 713 has the same phase as that of the frequency of XTAL (Crystal: crystal oscillator, not shown). As a result, the frequency of the transmission signals is set to an intended frequency (for example, 830.025 MHz).

The address logic circuit 715 imparts transmission signals with address data.

TX716 is a transmission processing apparatus (transmitter), and sends transmission signals to the outside (for example, the base station 300, a relay apparatus 310 or the like) through the antenna 80.

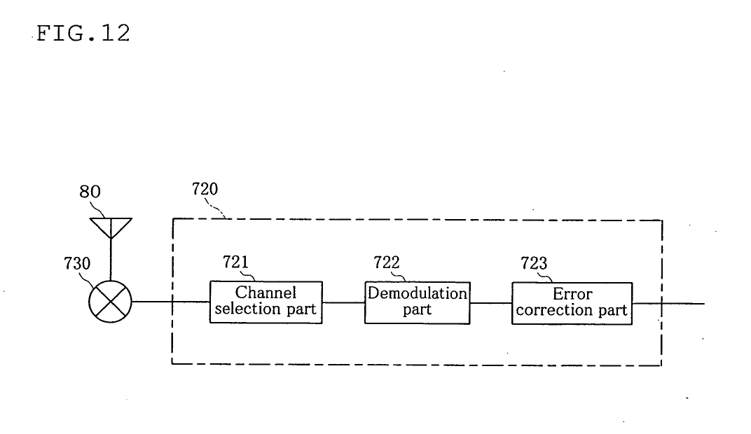

As shown in FIG. 12, the receiving part (receiving means) 720 has a channel selection part 721, a demodulation part 722 and an error correction part 723.

When one transmission channel is selected by a user by manipulation of an operation part (not shown), the channel selection part (address logic circuit) 721 receives an electric wave which has been sent by this transmission channel from the mixer 730, and sends it to the demodulation part 722 as receiving signals.

The demodulation part 722 receives the receiving signals from the channel selection part 722, and demodulates the receiving signals, thereby to obtain demodulated signals.

The error correction part 723 conducts error correction for the demodulated signals, and the data is returned to the TS packet. The TS packet contains, in addition to packets of a video image and voice, information necessary for data broadcasting, EPG and channel selection, or the like.

The mixer 730 sends transmission signals from the transmission part 710 to the antenna 80 to allow them to transmit. Further, the mixer 730 sends receiving signals from the antenna 80 to the receiving part 720.

Further, the mixer 730 can have a function of a duplexer. For example, when the antenna 80 has both the transmitting and receiving functions, the mixer 730 electrically separates a transmission path and a receiving path in order to prevent a strong transmission wave from to be flown in and received by the receiving part 720.

### (II) Communication Method

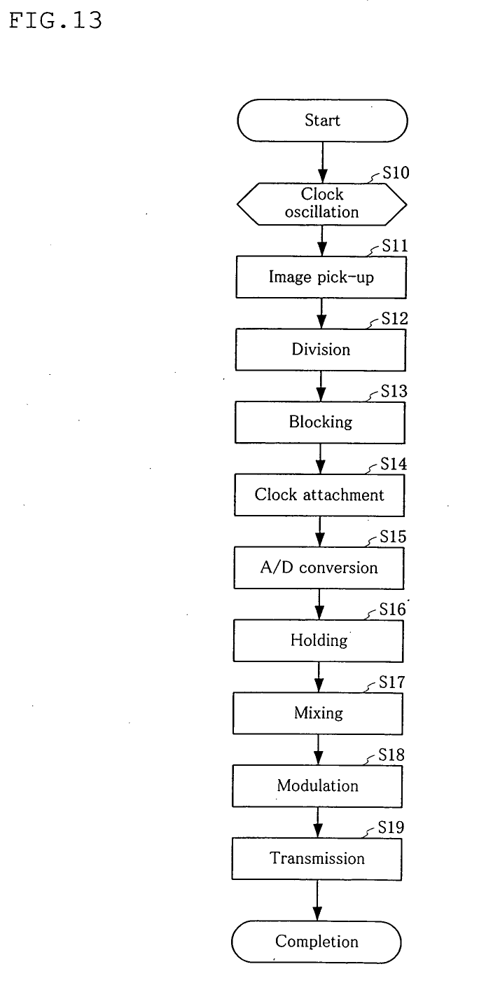

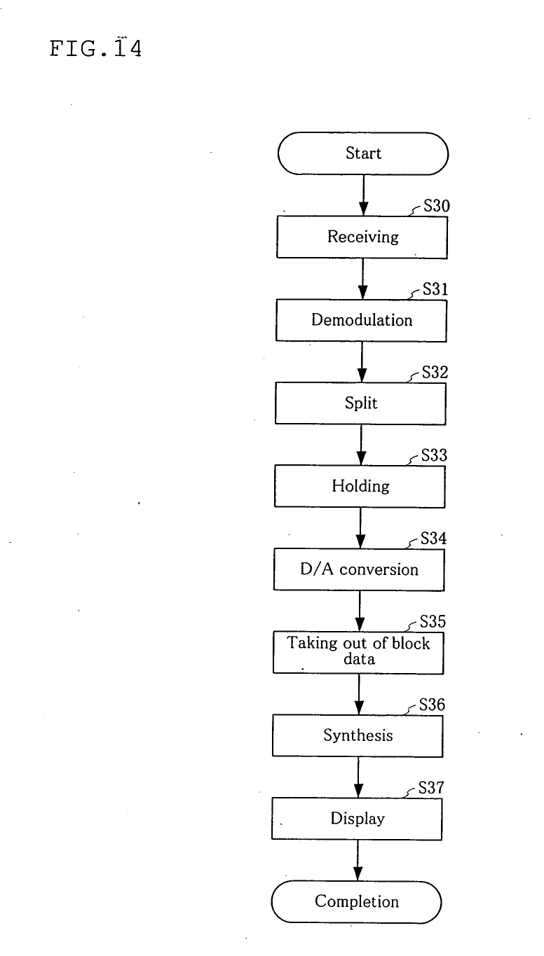

Next, the operation of the communication apparatus of this embodiment (communication method) will be explained with reference to FIGS. 13 and 14.

FIG. 13 is a flow chart showing the processing procedure of the transmitting method of the communication method. FIG. 14 is a flow chart showing the processing procedure of the receiving method of the communication method.

### (II-1) Transmission Method

A plurality of crystal oscillators 10-1 to 10-4 oscillates the clocks A to D which differ in frequency (Step 10 in FIG. 13). These clocks A to D are sent to the clock control means 20.

The image pick-up means 30 takes a still image or a moving image (Step 11). This picked-up image data is sent to the signal processing means 50a.

The division part 510 of the signal processing means 50a divides the picked-up image data according to each region which is formed when one image is divided into a plurality (four, in this embodiment) of regions (Step 12), and sends the divided data 1 to 4 to the transmission block processing part 520. Here, the divided data 1 is data for displaying the image of the region 1. The divided data 2 is data for displaying the image of the region 2. Further, the divided data 3 is data for displaying the image of the region 3. The divided data 4 is data for displaying the image of the region 4.

The transmission block processing part 520 blocks each of the divided data 1 to 4 according to the prescribed data amount (Step 13).

Subsequently, the transmission block processing part 520 puts the blocked data (block data) in a signal frame of a corresponding stage.

For example, the block data 1 which has been divided from the divided data 1 is put in the signal frame 1 of the stage 1 which corresponds to the region 1 indicated by the divided data 1. The block data 2 which has been divided from the divided data 2 is put in the signal frame 2 of the stage 2 which corresponds to the region 2 indicated by the divided data 2. The block data 3 which has been divided from the divided data 3 is put in the signal frame 3 of the stage 3 which corresponds to the region 3 indicated by the divided data 4. The block data 3 which has been divided from the divided data 4 is put in the signal frame 4 of the stage 4 which corresponds to the region 4 indicated by the divided data 4.

Subsequently, the transmission block processing part 520 receives the clocks A to D from the clock control means 20.

Then, for the signal frame in which the block data is put, the transmission block processing part 520 attaches a clock corresponding to this stage (or a clock corresponding to the region of the image indicated by the block data) (Step 14).

For example, for the signal frame 1 in which the block data 1 is put, the clock A corresponding to the stage 1 is attached. For the signal frame 2 in which the block data 2 is put, the clock B corresponding to the stage 2 is attached. For the signal frame 3 in which the block data 3 is put, the clock C corresponding to the stage 3 is attached. For the signal frame 4 in which the block data 4 is put, the clock D corresponding to the stage 4 is attached.

The transmission block processing part 520 sends both the block data put in the signal frame and the clock to the ND conversion part 530 as analogue transmission signals.

The A/D conversion part 530 converts analogue transmission signals to digital signals (Step 15), and sends the signals to the data control means 60a as digital signals.

The transmission signal correction part 610 of the data control means 60a stores and holds digital signals which have been sent from the ND conversion part 530 (Step 16).

When all of the digital signals for 30 frames in the four stages are stored in the transmission signal correction part 610, the mixer 620 takes out these digital signals from the transmission digital correction part 610 and mixes (Step 17). Then, the mixer 620 sends them to the transmission part 710 as mixed signals.

The transmission part 710 modulates a carrier by mixed signals (Step 18).

The transmission part 710 sends the modulated signals to the outside as transmission signals via the mixer 730 and the antenna 80 (Step 19).

### (II-2) Receiving Method

Next, the processing procedure of the receiving method in the communication apparatus will be explained with reference to FIG. 14.

The antenna 80 receives an electric wave which has been transmitted from the outside (Step 30).

The electric wave is sent to the receiving part 720 via the mixer 730 of the transmitting and receiving means 70 as receiving signals.

The receiving part 720 demodulates the receiving signals (Step 31), and sends the demodulated signals to the data control means 60a.

The splitter 630 of the data control means 60a splits the demodulated signals (Step 32), and divides them into the digital signals for each stage.

The thus divided digital signals are sent to the transmission signal correction part 640 and stored and held (Step 33).

The D/A conversion part 540 of the signal processing means 50a takes out the digital signals from the receiving signal correction part 640 and convert them to analogue signals (Step 34), and send them to the receiving block processing part 550 as analogue transmission signals.

The receiving block processing part 550 takes out a block data and clocks from the analogue transmission signals (Step 35), and sends each of them to the synthesizing part 560.

The synthesizing part 560 synthesizes block data based on the frequency of the clock (Step 36), and sends it to the display means 40 as the synthesized data.

The display means 40 displays an image based on the synthesized data (Step 37).

As explained hereinabove, according to the communication apparatus and the communication method of this embodiment, since video image data, which is analogue data, is divided into a prescribed number, a clock of a different frequency is attached to each of the divided data, and the divided data to which a clock has been attached is converted to digital data and transmitted to the outside, transmission of the divided data within the transmission carrier width becomes possible. As a result, transmitting and receiving of a video image which has a large data amount can be possible without performing compression and decompression. Further, since no compression and decompression is necessary, the time required for communication can be shortened, whereby video image data can be received and displayed on the real time basis. Further, since compression is no longer necessary, deterioration of image quality due to decompression can be prevented, whereby a video image can be displayed with a high image quality.

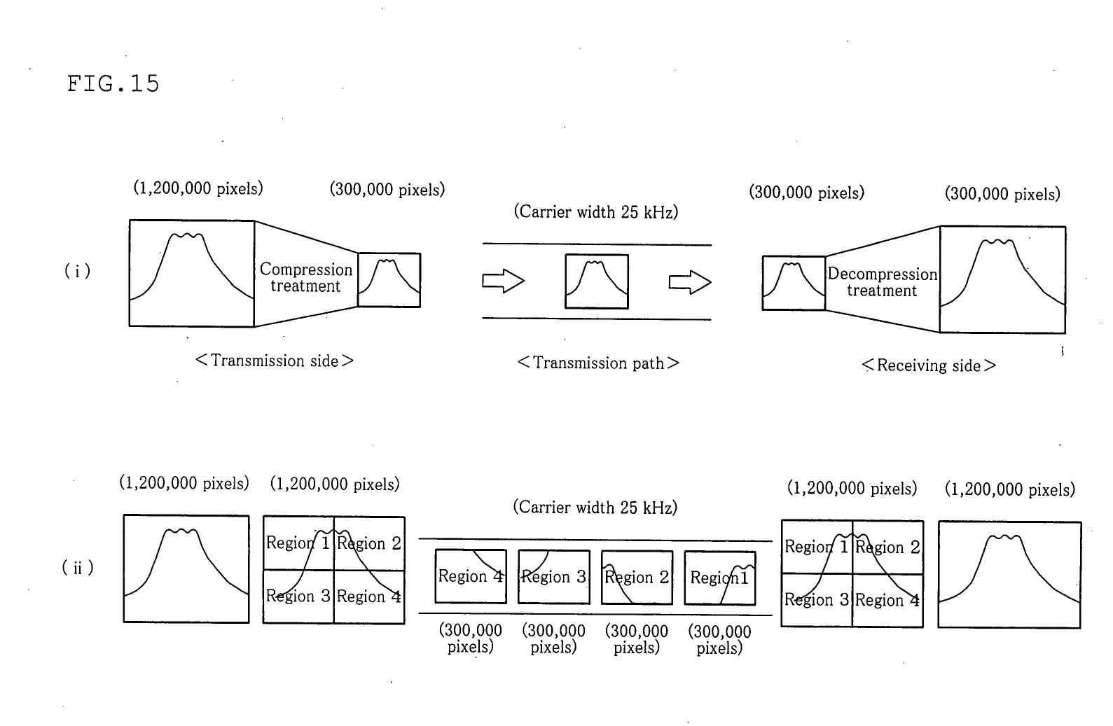

Next, comparison of the communication apparatus and the communication method of this embodiment and related technologies and advantageous effects of this embodiment will be explained with reference to FIGS. 15(i) and (ii).

FIG. 15(i) is a view showing the flow of the image transmission according to the related art. FIG. 15(ii) is a view showing the flow of the image transmission according to the communication apparatus and the communication method of this embodiment.

When an image is transmitted and received, in general, the image data was subjected to a compression treatment such that it can be transmitted through a transmission path (FIG. 15 (i)). For example, an apparatus on the transmission side of the related art allowed an original image of 1,200,000 pixels to be an image of 300,000 pixels by a compression treatment. This image data of 300,000 pixels is transmitted through a transmission path. An apparatus which receives this data conducts a decompression treatment. As a result, an apparatus on the receiving side can display the image on the screen.

However, the image data after decompression has 300,000 pixels, which is the same as that before compression, and is significantly smaller than 1,200,000 pixels of the original image data. As a result, an image with a deteriorated image quality is displayed by the apparatus on the receiving side. Further, because of compression and decompression treatments, the communication speed was lowered.

In contrast, in the communication apparatus of this embodiment, an image of 1,200,000 pixels can be divided into four divided data, each having 300,000 pixels (FIG. 15 (ii)). The thus divided data is sequentially transmitted to a transmission path. A communication apparatus on the receiving side receives these divided data and synthesizes. Since four divided data each having 300,000 pixels is synthesized, the thus synthesized image has 1,200,000 pixels. As a result, the communication apparatus of this embodiment can display a high-quality image on the screen without deterioration of image quality. Further, since no compression and decompression is conducted, communication speed can be increased.

Further, a clock of a different frequency is attached to each of the divided data. Each clock corresponds to any of a plurality of regions constituting an image. Therefore, a communication apparatus on the receiving side confirms the frequency of the clock, and as a result, can grasp that to which region of an image the received divided data belongs. As a result, without making a mistake on the region, divided data can be synthesized by correct arrangement.

### Second Embodiment of the Communication Apparatus and the Communication Method

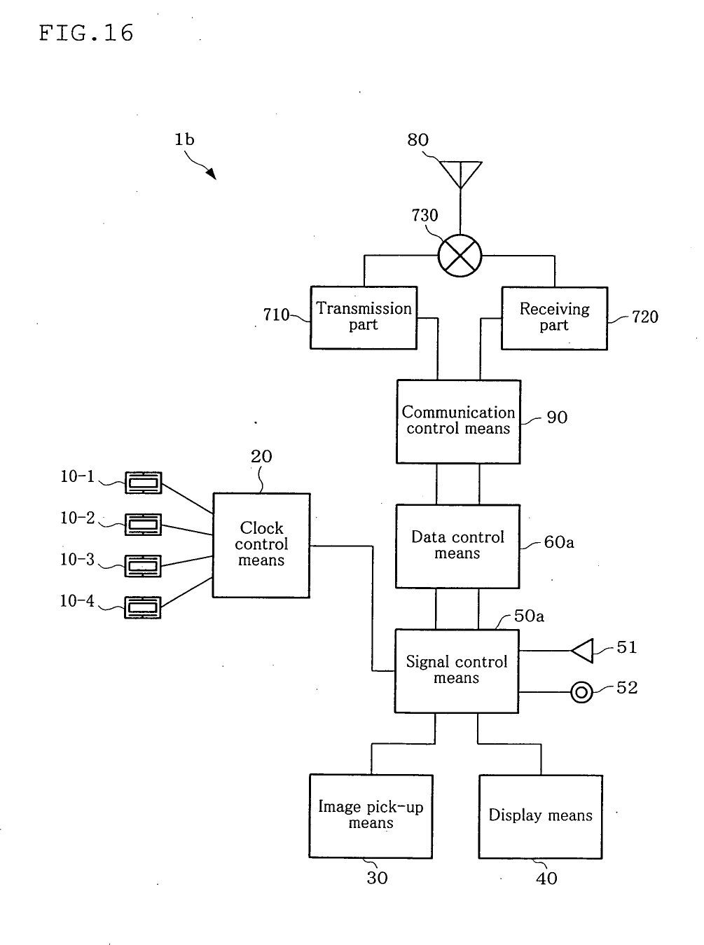

Next, the second embodiment of the communication apparatus and the communication method of the present invention will be explained with reference to FIG. 16.

FIG. 16 is a block diagram showing the configuration of the communication apparatus of this embodiment.

This embodiment differs from the first embodiment in that the apparatus is provided with a communication control means. Other constituting elements are the same as those in the first embodiment.

In FIG. 16, the same constituting elements as those in FIG. 1 are indicated by the same numerals, and the detailed explanation thereof is omitted.

### (I) Communication Apparatus

As shown in FIG. 16, a communication apparatus 1b is provided with the crystal oscillator 10, the clock control means 20, the image pick-up means 30, the display means 40, the signal processing means 50a, the data control means 60a, the transmitting and receiving means 70, the antenna 80 and a communication control means 90.

Here, the signal processing means 50a and the data control means 60a have the same function as those of the signal processing means 50a and the data control means 60a in the communication apparatus in the first embodiment.

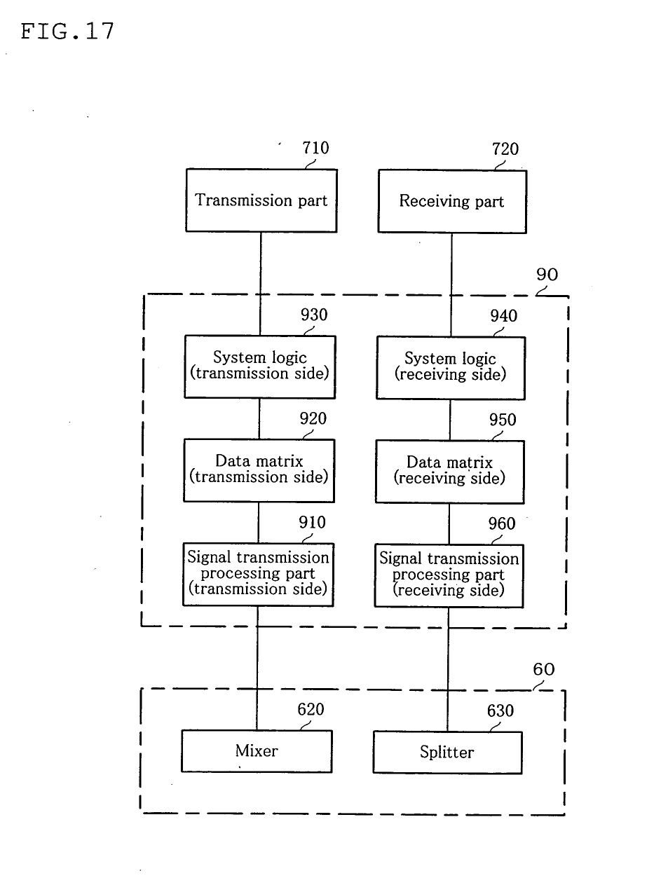

As shown in FIG. 17, the communication control means 90 is provided with a signal transmission processing part (transmission side) 910, a data matrix (transmission side) 920, a system logic (transmission side) 930, a system logic (receiving side) 940, a data matrix (receiving side) 950 and a signal transmission processing part (receiving side) 960.

The signal transmission processing part (transmission side) 910 sends the mixed signals which have been sent from the mixer 620 to the data matrix 920. The signal transmission processing part 910 forms emergency signals based on the manipulation of an operation means (not shown), and sends the emergency signals to the data matrix 920.

The data matrix (transmission side) 920 switches the transmission mode (normal mode) of the picked-up image data and the transmission mode (emergency transmission mode) of the emergency signals. Specifically, upon receiving of emergency signals, it holds the mixed signals which have been sent from the data control means 60a, and sends the emergency signals to the system logic 930. Further, upon completion of receiving of the emergency signals, it sends the thus held mixed signals (or mixed signals which have been sent from the data control means 60a afterwards) to the system logic 930.

The system logic (transmission side) 930 sends the mixed signals which have been sent from the data matrix 920 to the transmission part 710. Further, the system logic 930 has a filtering function. It cuts frequency components of the high-frequency region or the low-frequency region of the emergency signals, and sends them to the transmission part 710.

The system logic (receiving side) 940, upon receiving modulated signals from the receiving part 720, cuts overlapped noise components, and sends them to the data matrix 950.

The data matrix (receiving side) 950 judges whether the demodulated signals contain emergency signals or picked-up image data. The data matrix 950 sends the demodulated signals to the signal transmission processing part 960 together with the results of judgment.

The signal transmission processing part (receiving part) 960, if the demodulated signals received from the data matrix 950 contain emergency signals, conducts switching to the emergency display mode, and allows the display of the display means 40 to a display for emergency, whereby an emergency screen is displayed.

On the other hand, if the demodulated signals contain picked-up image data (or modulated signals do not contain emergency signals), the signal transmission processing part 960 sends the demodulated signals to the data control means 60a.

The communication apparatus 1b of this embodiment is provided with an operation part (not shown). The operation part is composed of a physical key or the like, and selects a prescribed instruction or function by the manipulation of a user.

### (II) Communication Method

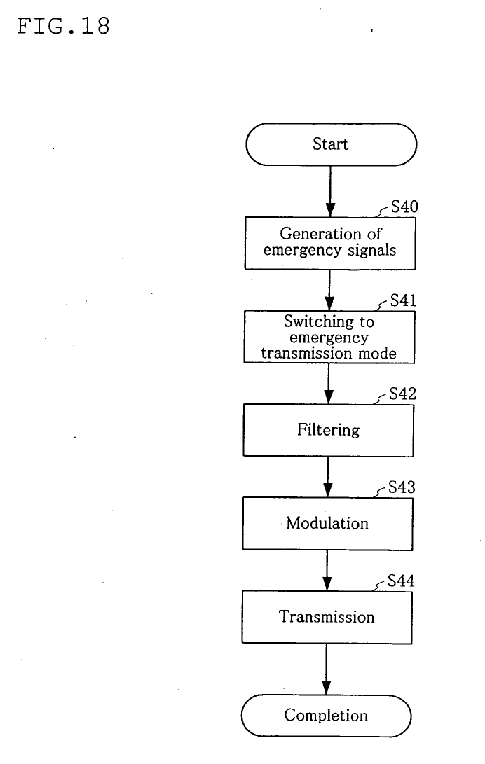

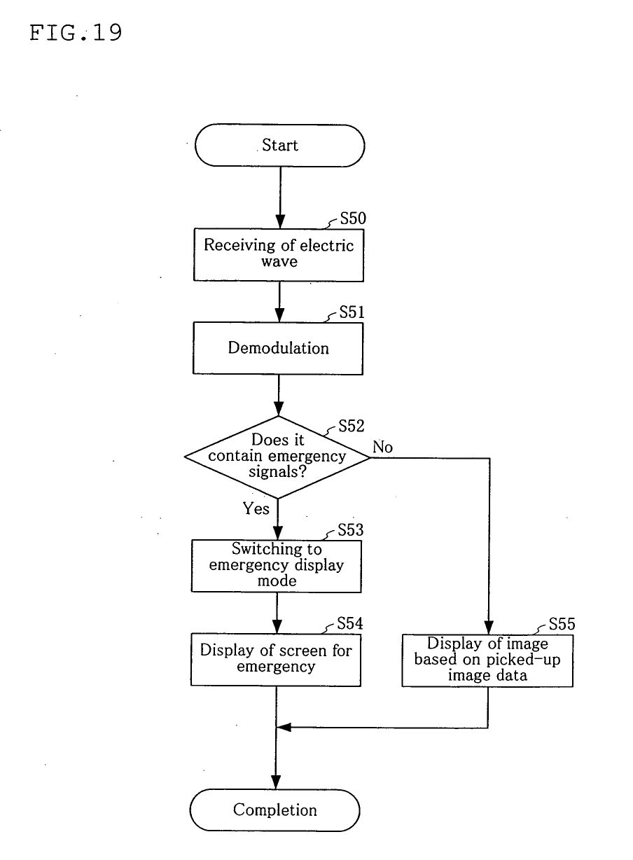

Next, the operation of the communication apparatus of this embodiment (communication method) will be explained with reference to FIGS. 18 and 19.

FIG. 18 is a flow chart showing the procedure of processing of the transmission method of the communication method of this embodiment. FIG. 19 is a flow chart showing the procedure of processing of the receiving method of the communication method of this embodiment.

### (II-1) Transmission Method

When transmission of emergency signals is instructed by the manipulation of the operation means by a user, the signal transmission processing part 910 of the communication control means 90 generates emergency signals (Step 40 of FIG. 18).

Upon receiving of the emergency signals, the data matrix 920 switches to the emergency transmission mode (Step 41), holds signals which have been sent from the data control means 60, and sends emergency signals to the system logic 930.

The system logic 930 conducts a filtering operation of emergency signals (filtering, Step 42), and sends the emergency signals to the transmission part 710.

The transmission part 710 modulates a carrier with the emergency signals (Step 43), and transmits the thus modulated carrier to the outside as transmission signals via the mixer 730 and the antenna 80 (Step 44).

### (II-2) Receiving Method

Upon receiving an electric wave from the outside via the antenna 80 (Step 50 in FIG. 19), the receiving part 720 modulates the wave (Step 51) and sends the modulated signals to the system logic 940.

The system logic 940 conducts noise processing of the modulated signals, and sends the modulated signals to the data matrix 950.

The data matrix 950 judges whether the modulated signals contain the emergency signals or the picked-up image data (Step 52). The data matrix 950 sends the results of judgment to the signal transmission processing part 960.

The signal transmission processing part (receiving part) 960, if the data matrix 950 judges that the modulated signals contain emergency signals, conducts switching to the emergency display mode (Step 53), and allows the display of the display means 40 to a display for emergency (Step 54). On the other hand, when the data matrix 950 judges that the modulated signals contain picked-up image data, the signal transmission processing part 960 sends the modulated signals to the data control means 60a. Thereafter, due to the processing at the data control means 60a and the signal processing means 50a, an image based on the picked-up image data is displayed on the display means 40 (Step 55).

As explained hereinabove, according to the communication apparatus and the communication method of this embodiment, not only the picked-up image data but also emergency signals can be handled.

In addition, by using one of a plurality of digital signals as an emergency signal, this emergency signal can also be transmitted at a high speed.

### Third Embodiment of the Communication Apparatus and the Communication Method

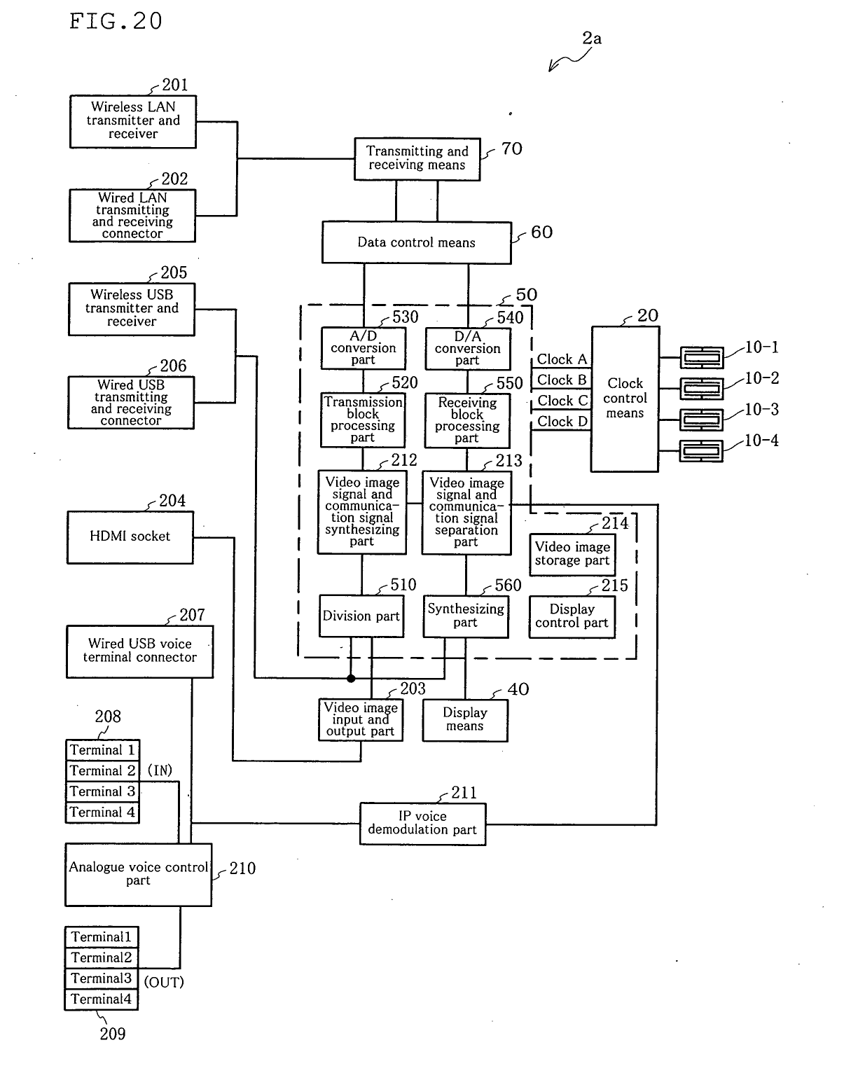

Further, the third embodiment of the communication apparatus and the communication method according to the present invention will be explained with reference to FIG. 20.

FIG. 20 is a block diagram showing the configuration of a web tuner which is the communication apparatus of this embodiment.

The web tuner (World Wide Web Tuner) of this embodiment has a configuration in which the communication apparatus of the first embodiment is provided.

Therefore, in FIG. 20, the same constituting elements as those in FIG. 1 are indicated by the same numerals and a detailed explanation thereof is omitted.

Here, a web tuner is a relay apparatus for a video image or voice which receives a video signal distributed through a communication line such as an Internet and sends the video signal to a TV monitor or the like to allow a vide image based on the video signal to be displayed.

The web tuner has a function of receiving video image communication signals based on a video image taken by the image-pick up apparatus, packetizing the signals, and distributing to the internet or the like as video image signals.

Specifically, it has functions of a set top box, e.g. functions of receiving broadcasting signals of cable television broadcasting, satellite broadcasting, digital terrestrial television broadcasting (digital broadcasting, analogue broadcasting), IP broadcasting (broadband VOD (Video on Demand)) or the like and converting the signals to signals which can be viewed on general televisions.

### (I) Configuration of a Web Tuner

As shown in FIG. 20, a web tuner 2a is provided with the crystal oscillator 10 (10-1 to 10-n), the clock control means 20, the display means 40, the control processing means 50, the data control means 60, the transmitting and receiving means 70, a wireless LAN transmitter and receiver 201, a wired LAN transmitting and receiving connector 202, the video image signal input and output part 203, an HDMI socket 204, a wireless USB transmitter and receiver 205, a wired USB transmitting and receiving connector 206, a wired USB voice terminal connector 207, a voice input terminal 208, a voice output terminal 209, an analogue voice control part 210 and an IP voice demodulation part 211.

Here, the plurality of crystal oscillators 10 (10-1 to 10-n) generate the clocks A to D which have different frequencies, and supply the clocks to the clock control means 20.

In this embodiment, four crystal oscillators 10 are provided. However, the number of the clocks is not limited to four, and two, three or five or more crystal oscillators may be provided.

The clock control means 20 supplies one or two or more of the clocks A to D to the signal control means 50.

The transmission part 710 of the transmitting and receiving means 70 packetizes the mixed signals from the data control means 60, and transmits this packet as transmission signals. These transmission signals are transmitted to other apparatus connected to LAN through the wireless LAN transmitter and receiver 201 or the wired LAN transmitting and receiving connector 202.

The IP packet (Internet Protocol Packet) is provided with a header part and a data part.

The header part is a part composed of a version, a header length, a service type, a datagram length, ID, source IP address, destination IP address or the like.

The data part is a part in which data to be transmitted is placed. The mixed signals can be placed in this part.

The wireless LAN transmitter and receiver 201 transmits and receives data by the wireless communication with other apparatuses constituting a wireless LAN.

The wireless LAN includes a network composed of various apparatuses which are in compliance with IEEE802.11.

The web tuner 2a of this embodiment can be positioned at the terminal of the Wireless LAN.

Specific examples of the wireless LAN transmitter and receiver 201 include a wireless LAN card (wireless LAN adapter).

A wireless LAN card is an extension card which is inserted into an USB port (not shown) of the web tuner 2a to provide a function of connecting to the wireless LAN. The wireless LAN card includes media converters which allow communication of the web tuner 2a which has only a wired LAN interface to be wireless.

The wireless LAN transmitter and receiver 201 can be provided as a communication modem (wireless LAN modem, ADSL and optical modem), for example.

The wired LAN transmitting and receiving connector 202 is a connector (terminal on the receiving side) to which a LAN cable as an external terminal is connected. Examples of the LAN cable include twisted pair cables, coaxial cables and optical fibers. One of the connectors of this LAN cable (insertion terminal) is connected to this wired LAN transmitting and receiving connecter 202 (terminal on the receiving side), and the other connector (insertion terminal) is connected to a hub or a computer, a printer or the like which are present in the same building, whereby data transmission can be conducted between them.

The receiving part 720 of the transmitting and receiving means 70 receives an IP packet from the wireless LAN transmitter and receiver 201, the wired LAN transmitting and receiving connector 202 or the mixer 730 (see FIG. 1) as receiving signals, takes the mixed signals from the data part of this IP packet and sends them to the data control means 60.

The video image signal input and output part 203 sends video image data which has been input through the HDMI socket 204 to the signal processing means 50. Further, the video image signal input and output part 203 sends video image data generated by the signal processing means 50 to external apparatuses through the HDMI socket 204.

The HDMI socket 204 is a socket which transmits and receives video image data or voice data using a HDMI (High-Definition Multimedia Interface).

HDMI is an interface standard for input and output digital video image or voice mainly for household appliances or AV equipment. Since video image, voice and control signals are transmitted and received simultaneously with a single cable, wiring can be conducted easily. Optionally, control signals can be bi-directionally transmitted, and by relaying data between apparatuses, a plurality of AV appliances can be controlled by a single remote controller.

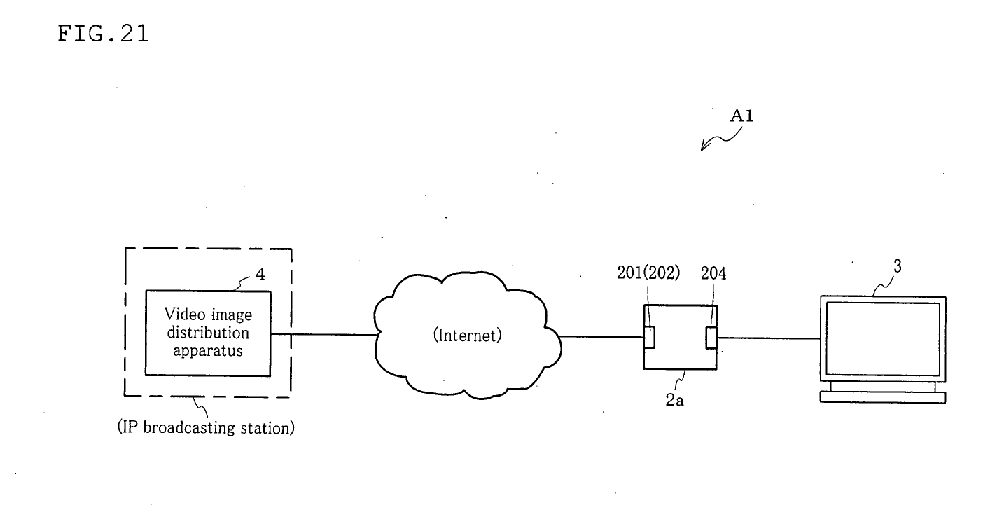

As shown in FIG. 21, a large-sized monitor (display) 3 or the like can be connected to this HDMI socket 204 (image transmission system A1).

The display means 40 has a liquid crystal display screen, and can display a plurality of keys or a video image based on the video image data on this liquid crystal display screen. A user pushes (selects) keys displayed on the display means 40, whereby various settings relating to the functions of the web tuner 2a can be conducted. That is, the display means 40 has a function as an input operation part. This input operation part may include a physical switch which is not shown in the liquid crystal display screen.

The display-means 40 may have a configuration as a remote controller which is separated from the main body of the web tuner 2a. In this case, a signal transmitting and receiving means is provided in each of the main body of the web tuner 2a and the remote controller.

The wireless USB transmitter and receiver 205 can transmit and receive video image data or the like with appliances or apparatuses which can conduct wireless USB communication (video image processing apparatus).

Wireless USB (Universal Serial Bus) is a technology/standard in which wireless technology utilizing an ultra wide band (Ultra Wide Band), is used and the MB-OFDEM method is used in the physical layer or the MAC layer, thereby to extend the USB.

The video image processing apparatus is an apparatus provided with one or two or more functions relating to a video image (for example, image pick-up (photographing), recording, processing (editing, splitting, synthesizing or the like), display, external input and output (transmitting and receiving) or the like. Specific examples thereof include a personal computer, a digital camera, a disc player/recorder (CD, MD, DVD or the like), a video deck, a mobile phone, PHS and PDA.

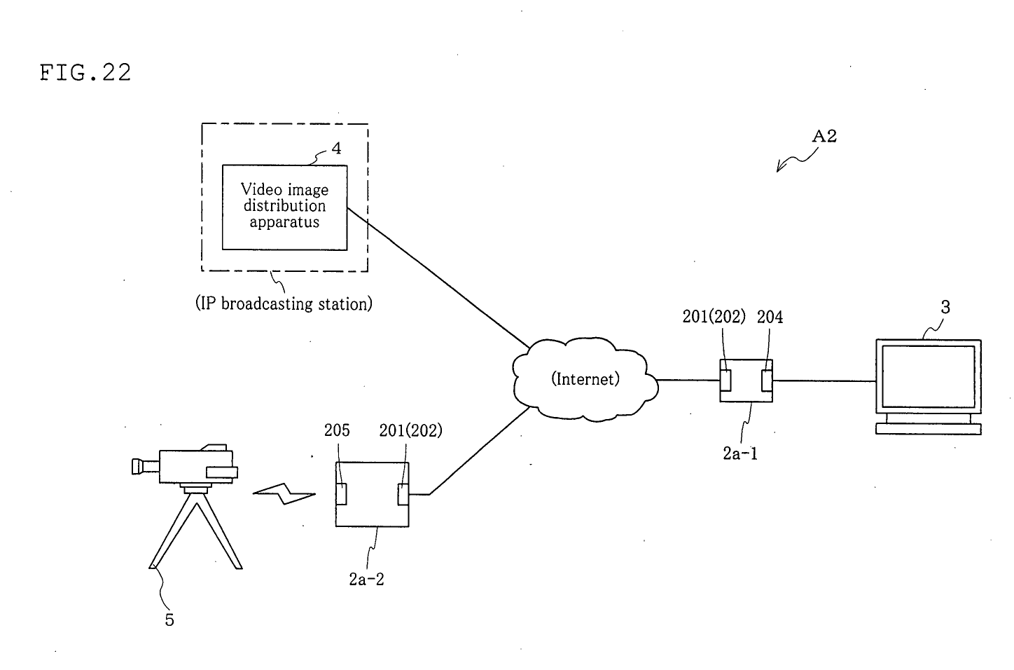

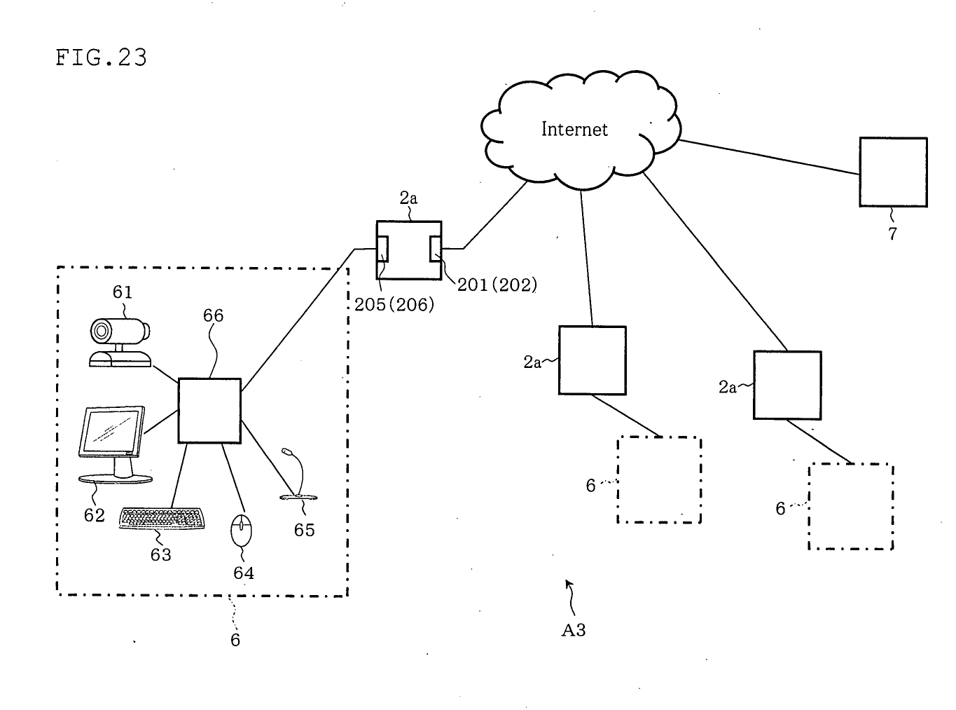

As shown in FIG. 22, a news camera (image-pick up apparatus) 5 may be connected to the wireless USB transmitter and receiver 205 (image transmission system A2). Further, as shown in FIG. 23, a control apparatus on the user side 66 of a TV conference user system 6 constituting a TV conference system A3 can be connected to the wireless USB transmitter and receiver 205 (image transmission system A3).

To the wired USB transmitting and receiving connector 206, an USB cable is connected as an external terminal, whereby video image data is transmitted and received between the connector and the video image processing apparatus.

As the standard for a USB cable, for example, standards for a high/full speed transmission and standards for a low speed transmission can be given. On the both ends of a USB cable, an A terminal, a B terminal, a miniature USB terminal or the like are used.

In this embodiment, the wireless LAN transmitter and receiver 201, the wired LAN transmitting and receiving connector 202, the HDMI socket 204, the wireless USB transmitter and receiver 205 and the wired USB transmitting and receiving connector 206 have a function as a “transmitting means” since they send video image data to a prescribed apparatus (video image processing apparatus or the like).

Further, in this embodiment, the wireless LAN transmitter and receiver 201, the wired LAN transmitting and receiving connector 202, the HDMI socket 204, the wireless USB transmitter and receiver 205 and the wired USB transmitting and receiving connector 206 have a function as a “receiving means” since they receive video image data from a prescribed apparatus (a video image processing apparatus, for example).

The wired USB voice terminal connector 207 is a terminal which is connected to a voice network though an USB cable, which sends voice signals which have been transmitted from a voice network to an IP voice demodulation part 211. Further, the wired USB voice terminal connector 207 transmits voice signals from the IP voice demodulation part 211 to an apparatus connected to a voice network through a USB cable.

The voice network means, for example, an IP (Internet Protocol) network in which a voice is compressed by various encoding methods, converted into a packet by means of a VoIP (Voice over Internet Protocol) and transmitted on the real time basis.

A voice input terminal 208 receives voice signals from the outside and sends them to an analogue voice control part 210.

A voice output terminal 209 outputs voice signals which has been sent from the analogue voice control part 210 to the outside.

The analogue voice control part 210 converts voice signals from the voice input terminal 208 to prescribed voice signals and sends the signals to the IP voice demodulation part 211. Further, the analogue voice control part 210 converts voice signals from the IP voice demodulation part 211 to prescribed voice signals, and output the signals from the voice output terminal 209 to the outside.

The IP voice demodulation part 211 demodulates voice signals which have been transmitted from the wired USB voice terminal connector 207 or the analogue voice control part 210. Then, it sends the thus demodulated voice signals and the voice signals which have been sent from the analogue voice control part 210 to the video image signal and communication signal synthesizing part 212.

Further, the IP voice demodulation part 211 sends voice signals which have been sent from a video image and communication signal separation part 213 to the wired USB voice terminal connector 207 or the analogue voice control part 210, and allows them to be output to the outside.

As shown in FIG. 20, the signal processing means 50 is provided with the division part 510, the transmission block processing part 520, the ND conversion part 530, the D/A conversion part 540, the receiving block processing part 550, the synthesizing part 560, the video image signal and communication signal synthesizing part 212, the video image and communication signal separating part 213, the video image storage part 214 and the display control part 215.

The division part 510 divides video image data which has been sent from the video image signal input and output part 203, the wireless USB transmitter and receiver 205 and the wired USB transmitting and receiving connector 206 or video image data which has been taken out from the video image storage part 214.

The video image signal and communication signal synthesizing part 212 synthesizes the divided data from the division part 510 and voice signals which have been sent from the IP voice demodulation part 211.

The receiving block processing part 550 separates block data and clocks from analogue transmission signals which have been sent from the D/A conversion part 540.

The video image signal and communication signal separation part 213 separates voice signals from the block data from the receiving block processing part 550, and sends the thus separated voice signals to the IP voice demodulation part 211.

The synthesizing part 560, when it receives from the image data signal and communication signal separation part 213 a plurality of block data from which the voice signals have been separated, synthesizes these plurality of block data. The thus synthesized video image data is sent to and stored in the video image storage part 214.

The video image storage part 214 stores video image data which has been input through the wireless LAN transmitter and receiver 201 or the wired LAN transmitting and receiving connector 202, a video image data which has been transmitted from the video image signal input and output part 203, the wired USB transmitter and receiver 205 and the wired USB transmitting and receiving connector 206, the video image data (divided data) which has been divided by the division part 510, the video image data synthesized by the synthesizing part 560 or the like. In addition to these, it can store voice signals, text data or the like.

The display control part 215 takes video image data from the video image data storing part 214, sends it to the display means 40, and allows a video image based on this video image data to be displayed on the screen. Further, based on the operation at the display means 40, it allows other constituting elements of the web tuner 2a to execute a prescribed operation. In addition, the display control part 215 can allow the video image data which has been synthesized by the synthesizing part 560 to be output to the outside from the HDMI socket 204 through the video image signal input and output part 203.

The signal control means 50 can supply voice signals corresponding to voice sounds generated by a user which has been input by the microphone 52 or data signals (indicating an image, a character or the like) supplied from the outside through a data input and output multi-connector (not shown) to the data control means 60.

The signal processing means 50 processes transmission signals which have been supplied from the data control means 60. For example, if the digital signals which have been supplied from the data control means 60 relate to voice, the signal processing means 50 converts the digital signals to analogue voice signals, and supplies the voice signals to a loud speaker 51 and allows them to be output. If the digital signals relate to data (for example, indicating an image, a character, or the like), the signal processing means 50 converts the digital signals to analogue data signals and supplies them to the display means 40 or the outside, or supplies them as the digital signals without conversion to the display means 40 or the outside.

Further, the data control means 60 has the similar function as that of the data control means 60a in the communication apparatus according to the first embodiment.

By allowing a web tuner to have such a configuration, it is possible to divide video image data, attach to each of the divided video image data the clocks A, B, C and D which have different frequencies, conduct ND conversion and transmit the digital signals in the data part of the IP packet.

Since the video image data can be transmitted after being divided into four, compression becomes unnecessary. As a result, deterioration of the image quality caused by decompression can be prevented. Further, since time required for compression or decompression can be saved, high-speed transmission of video image data can be realized.

### (II) Image Transmission System (Communication System)

Next, the configuration of the image transmission system using the web tuner of this embodiment will be explained with reference to FIGS. 21 to 24.

Various apparatuses can be connected to the web tuner 2a.

For example, as shown in FIG. 21, a large-sized monitor (display apparatus) 3 can be connected to the HDMI socket 204 of the web tuner 2a. In addition, the wireless LAN transmitter and receiver 201 (or the wired LAN transmitting and receiving connector 202) can be connected to a video image distribution apparatus 4 of the IP station (image transmission system A1).

As a result, a program video image which has been transmitted from the video image distribution apparatus 4 (video image communication signal) is received by the web tuner 2a. The web tuner 2a outputs them as video image signals, and the video image signals are then input in the large-sized monitor 3, whereby a video image based on this video image signal can be displayed.

The IP broadcasting (web broadcasting) is broadcasting in which a video image or voice to be broadcasted is transmitted or received through an internet, and is allowed to be viewed on a usual television.

As shown in FIG. 22, in addition to the configuration shown in FIG. 21, another web tuner (first web tuner) 2a-2 can be added. A news camera (camera apparatus) 5 can be connected to the wired USB transmitter and receiver 205 of this web tuner 2a-2, thereby enabling the wireless LAN transmitter and receiver 201 (or the wired LAN transmitting and receiving connector 202) to attain internet connection (Image transmission system A2).

As a result, an image as an object to be photographed which has been taken by the news camera 5 is received by the web tuner 2a-2 as picked-up image signals, and the picked-up image signals are then transmitted to the video image distribution apparatus 4 through an internet. Further, video image communication signals are transmitted from the video image distribution apparatus 4 to the web tuner (the second web tuner) 2a-1 through an internet. Then, video image signals based on the video image communication signals are sent from the first web tuner 2a-1 to the large-sized monitor 3, whereby a video image based on these video image signals is displayed.

According to such a processing, since no compression is conducted by the web tuner of this embodiment, high-speed distribution of a video image becomes possible, whereby a live image of news can be viewed on the real-time basis.

Further, video image distribution by the image transmission system A2 can be conducted by the broadband wireless LAN system.

The broadband wireless LAN system means public wireless LAN which enables wireless internet connection outdoors (local area network).

Further, as shown in FIG. 23, the TV conference user system 6 of the TV conference system can be connected to the wireless USB transmitter and receiver 205 (or the wired USB transmitting and receiving connector 206) of the web tuner 2a (image transmission system A3).

The TV conference system means an apparatus which allows a plurality of people who are present at distant places to communicate on the screen of a monitor while watching the other's faces.

The TV conference control apparatus (video image distribution apparatus) 7 constituting the TV conference system is connected to an internet.

Here, the TV conference user system 6 is provided with a cameral apparatus 61 which takes a photograph of a user, a display apparatus 62 which displays a prescribed video image, a keyboard 63 and a mouse 64 which are operated by a user, a microphone 65 which takes in the voice of a user, and a control apparatus on the user side 66 which controls various signals to be treated by the TV conference user system.

A video image of a user which is taken by the camera apparatus 61 is sent to the control apparatus on the user side 66 as picked-up video image signals. Together with the voice signals which have been taken by the microphone 65, the control apparatus on the user side 66 sends the picked-up video image signals to the web tuner 2a. The web tuner 2a transmits the picked-up image signals to a TV conference control apparatus 7 through an internet. The TV conference control apparatus 7 stores picked-up image signals or voice signals received by the plurality of web tuners 2a, and at the same time, it distributes them to each of the web tuners 2a. The web tuner 2a transmits the picked-up image signals and voice signals which have been distributed to the control apparatus on the user side 66. The control apparatus 66 on the user side sends picked-up video image signals to the display apparatus 62. As a result, the display device 62 displays a video image based on the picked-up image signals. Further, the control apparatus on the user side 66 sends voice signals to a loud speaker (not shown), and allows them to be output as voice.

Due to such a configuration, since multiplex transmission of video image signals by clock control is conducted by means of the web tuner 2a, a video image taken by the camera apparatus 61 can be displayed on the display apparatus 62 of other TV conference user systems 6.

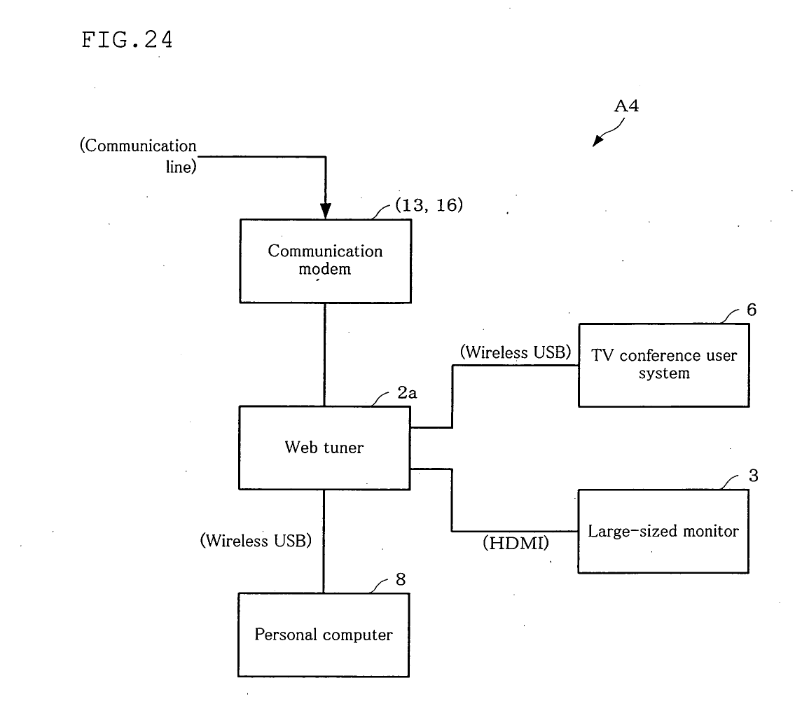

Further, as shown in FIG. 24, it can be a system in which a large number of video image processing apparatuses, such as a large-sized monitor 3, a TV conference user system 6, a personal computer 8 or the like, are simultaneously connected (image transmission system A4).

As mentioned above, the web tuner of this embodiment can be used for various purposes.

### (III) Communication Method

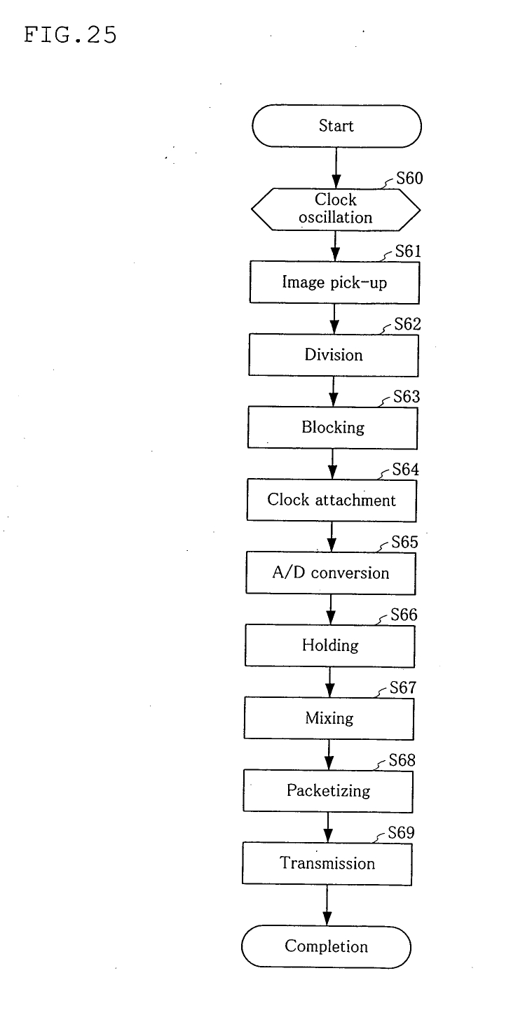

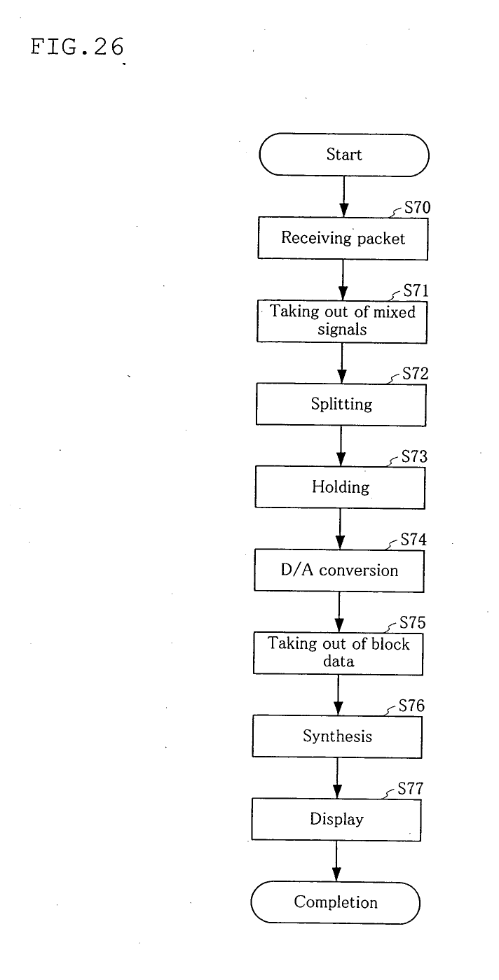

Next, the operation of the web tuner (communication method) of this embodiment will be explained with reference to FIG. 25 and FIG. 26.

FIG. 25 is a flow chart showing the processing procedure of the transmission method of the communication method of this embodiment. FIG. 26 is a flow chart showing the processing procedure of the receiving method of the communication method of this embodiment.

### (III-1) Transmission Method

A plurality of oscillators 10 each oscillates a clock of a different frequency (Step 60 of FIG. 25).

When a video image processing apparatus such as the news camera 5 takes a video image (image pick-up, Step 61), it sends the video image to the web tuner 2a as the video image data.

The wireless USB transmitter and receiver 205 of the web tuner 2a (or the wired USB transmitting and receiving connector 206) receive the video image data and send it to the signal processing means 50. As shown in FIG. 3(i), the video image at this point of time shows the whole surface (entire image) thereof. This image data is stored in the video image storage part 214 of the signal processing means 50.

Subsequently, as shown in FIG. 3(iii), the division part 510 divides the video image data in correspondence with a plurality of (four, in this embodiment) regions (Step 62). The video image data after the division is stored in the video image storage part 214 as the divided data.

The transmission block processing part 520 takes out the divided data from the video image storage part 214.

Here, when a voice signal is input in the IP voice demodulation part 211, the video image signal and communication signal synthesizing part 212 sends the voice signal to the transmission block processing part 520.

Subsequently, the transmission block processing part 520 divides the divided data (including voice signals when voice signals are input) according to a prescribed data amount, thereby to generate block data (blocking, Step 63).

Then, the transmission block processing part 520 puts the block data in the signal frame of the corresponding stage. Further, the transmission block processing part 520 attaches to the signal frame a clock corresponding to the stage (Step 64), and sends the block data which has been put in the signal frame and the clock which has been attached thereto to the A/D conversion part 530 as the analogue transmission data.

The A/D conversion part 530 converts the analogue transmission data to digital data (Step 65), and sends the thus digitalized data to the data control means 60 as digital signals.

The transmission signal correction part 610 of the data control means 60 retains the digital signals (Step 66).

The mixer 620 takes the digital signals from the transmission signal correction part 610 and mixes the signals (Step 67), and sends them to the transmission part 710 as the mixed signals.

The transmission part 710 allows the mixed signals to be placed in the data part of the IP packet (packetizing, Step 68), and transmits them as transmission signals to an internet (or apparatuses connected thereto) through the wireless LAN transmitter and receiver 201 or the wired LAN transmitting and receiving connector 202 (Step 69).

### (III-2) Receiving Method

The wireless LAN transmitter and receiver 201 (or the wired LAN transmitting and receiving connector 202) receives an IP packet which has been transmitted from other apparatuses through an internet (Step 70 in FIG. 26).

The receiving part 720 of the transmitting and receiving means 70 receives this IP packet from the wireless LAN transmitter and receiver 201 (or the wired LAN transmitting and receiving connector 202).

The receiving part 720 takes out from the mixed signals from the data part of the IP packet (Step 71), and sends these mixed signals to the data control means 60.

The splitter 630 of the data control means 60 splits the mixed signals (Step 72), and sends them to the receiving signal correction part 640 as digital signals.

The receiving signal correction part 640 store/holds the digital signals (Step 73).

Here, during the time from the arrival of data signal 1 to the arrival of data signal 4, data signals 1, 2 and 3 are sequentially held (chained) in the receiving signal correcting part 640. The data signals are held a with a time difference, whereby 30 or 60 image frames are formed in a four-in-one set.

The D/A conversion part 540 of the signal control means 50 takes out the digital signals from the receiving signal correction part 640, and converts them to analogue signals (Step 74), and send them to the receiving block processing part 550 as analogue transmission signals.

The receiving block processing part 550 separates block data and clocks from the analogue transmission signals (taking out of the block data, Step 75), and sends the block data and the clock to the synthesizing part 560.

If voice data is contained in the block data, the voice data is sent to the wired USB voice terminal connector 207 or the voice output terminal 209 through the video image signal and communication signal separation part 213 and the IP voice demodulation part 211.

The synthesizing part 560 synthesizes the block data based on the frequency of the clock (Step 76) and sends the synthesized data to the video image storage part 214.

The display control part 215 sends the synthesized data to the video image signal input and output part 203. The video image signal input and output part 203 sends the synthesized data to the display part 3 through the HDMI socket 204, and allows a video image based on the synthesized data to be displayed on the display apparatus 3 (Step 77).

Here, the display control part 215 can take out the synthesized data stored in the video image storage part 214, send the data to the display means 40 and allow the data to be displayed.

In this embodiment, the mixer 620 of the data control means 60 mixes the digital signals to generate mixed signals. However, mixing by means of the mixer 620 can be omitted.

Further, in this embodiment, the splitter 630 of the data control means 60 splits the digital signals contained in the IP packet. However, splitting by means of the splitter 630 can be omitted.

In the above-mentioned case, the plurality of digital signals stored in the transmission signal correction part 610 are sent to the transmission part 710, and are independently placed in the data part of the IP packet. In the web tuner on the receiving side, a plurality of IP packets is received by the receiving part 720. No splitting by means of the splitter 630 is conducted, and the digital signals are taken out from each, of the plurality of IP packets and are stored in the receiving signal correction part 640. In the D/A conversion part 540, the digital signals are converted to the analogue transmission signals. In the synthesizing part 560, based on each frequency of the clock taken out from the plurality of analogue transmission signals, the block data which has been taken out from the analogue transmission signals are arranged to form an image.

As mentioned above, according to the communication apparatus and the communication method in this embodiment, video image data is divided, each of the thus divided data is subjected to blocking, a clock is attached to the block data, thereby to digitalize the data, and the digital data is transmitted after being packetized. Accordingly, compression and decompression are no longer necessary, whereby high-speed transmission of a video image can be realized. Further, deterioration of image quality can be prevented.

### Fourth Embodiment of the Communication Apparatus and the Communication Method

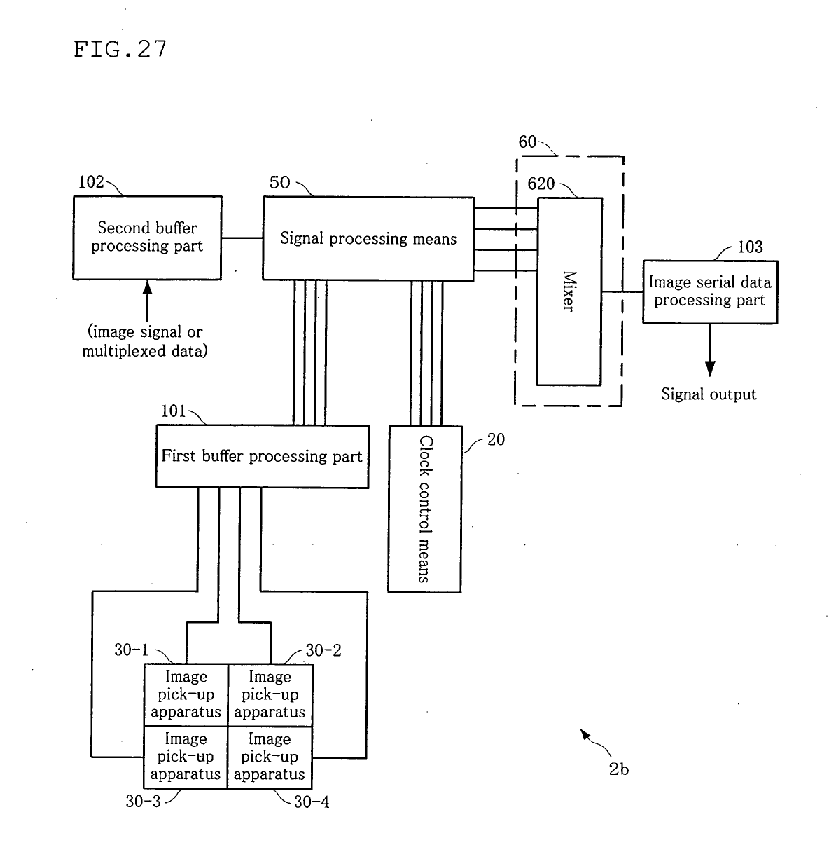

Next, the fourth embodiment of the communication apparatus and the communication method of the present invention will be explained with reference to FIG. 27.

FIG. 27 is a block diagram showing the configuration of the web tuner which is a communication apparatus of this embodiment.

This embodiment differs from the first embodiment that the communication apparatus is provided in the web tuner and the web tuner is provided with a plurality of image pick-up apparatuses as the video image processing apparatus. Other constituting elements are the same as those in the first embodiment.

In FIG. 27, the same constituting elements as those in FIG. 1 are indicated by the same numerals, and the detailed explanation thereof is omitted.

As shown in FIG. 27, the web tuner 2b is provided with image-pick up apparatuses 30-1 to 30-4, a first buffer processing part 101, a second buffer processing part 102, the clock control means 20, the signal processing means 50, the data control means 60 and an image serial data processing part 103.

Here, as the image-pick up apparatuses 30-1 to 30-4, a CCD camera can be used, for example.

A CCD camera is an apparatus which takes a photograph of an object using CCD (Charge Coupled Device). A CCD is an imaging element which sequentially transfers charges which have been accumulated in a photodiode to an output circuit by using transfer CCD and reads out.

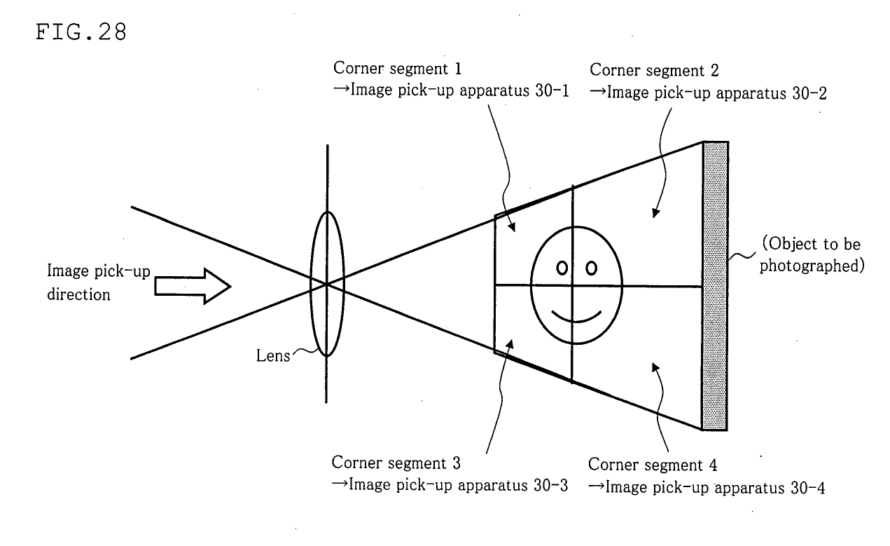

In this embodiment, as shown in FIG. 28, four CCD cameras are provided. Each of the CCD cameras is allocated to each segment obtained after dividing an object into four segments. That is, one corner segment of the object is allocated to one CCD camera.

The first buffer processing part 101 directly receives a video image taken by each of the image-pick up apparatuses 30-1 to 30-4 as video image signals and stocks (holds).

The second buffer processing part 102 stocks signals (video data, multiplexed data) which have been input from the wireless USB transmitter and receiver 205, the wired USB transmitting and receiving connector 206 and the HDMI socket 204 (video image signal input and output part 203).

The clock control means 20 corresponds to the clock control means 20 of the communication apparatus 1 (see FIG. 1).

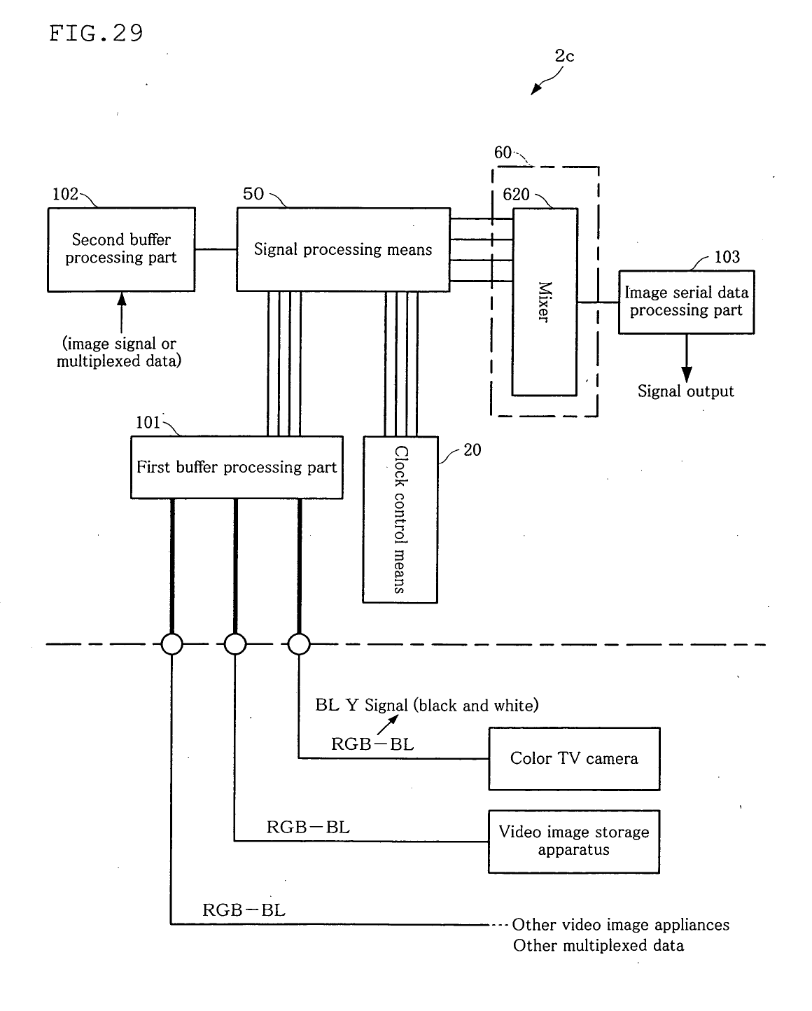

The web tuner 2b in this embodiment is provided with the crystal oscillator 10 (10-1 to 10-n). However, it is not shown in FIG. 27 and FIG. 29 (mentioned later).

The signal processing means 50 corresponds to the signal processing means 50a of the communication apparatus 1 (see FIG. 1).

The signal processing means 50 can conduct a separation treatment based on three primary colors. For example, the signal processing means 50 separates the video signals which have been input from the first buffer processing part 101 or the second buffer processing part 102 into four colors; i.e. red, green, blue and black.

The reason for allowing the color to be separated to be three primary colors (R, G, B) of light is that other colors (intermediate colors) can be formed by mixing the three primary colors of light. If the three primary colors of light are mixed, the resulting color becomes white. In order to adjust the brightness, black is added.

In this way, the video image signals are separated by the three primary colors of light, and according to the processing procedures shown in FIG. 13 and FIG. 14, transmission signals are generated in such a manner that red is used for the digital signal 1, green is used for the digital signal 2, blue is used for the digital signal 3 and black is used for the digital signal 4. By transmitting these signals, a high-quality image containing a small amount of cross color and suffering only slight deterioration of image quality can be obtained.

The data control means 60 corresponds to the data control means 60a of the communication apparatus 1a of the first embodiment. The mixer 620 corresponds to the mixer 620 of the communication apparatus 1a of the first embodiment.

The image serial data processing part 103 corresponds to the wireless LAN transmitter and receiver 201 or the wired LAN transmitting and receiving connector 202 of the web tuner 2a.

This embodiment differs from the first embodiment in that a plurality of image-pick up apparatus, which is a video image processing apparatus, is provided and that a video image signal is separated based on the three primary colors of light. Therefore, the communication method of this embodiment is the same as the communication method in the first embodiment, except that a plurality of video image data is taken and video image signals are separated based on the three primary colors of light.

As explained hereinabove, according to the communication apparatus and the communication method of this embodiment, it is possible to divide video image signals, and to transmit each of the thus divided video image data in a multiplexed way based on a plurality of clocks. As a result, high-speed transmission of a video image can be realized, whereby live image distribution of a real image can be possible.

The web tuner 2b shown in FIG. 27 has a configuration in which an image-pick up apparatus is connected as the video image processing apparatus. The configuration of the web tuner 2b is, however, not limited thereto. For example, as shown in FIG. 29, the web tuner 2b may have a configuration in which a color TV camera, a video image storage apparatus (VTR, DVD, or the like) and other video image apparatus can be connected to the first buffer processing part 101. Further, other multiplexed data can be input.

### Fifth Embodiment of the Communication Apparatus and the Communication Method

Next, the fifth embodiment of the communication apparatus and the communication method of the present invention will be explained.

The communication apparatus of this embodiment is a mobile phone. In this mobile phone, the communication apparatus according to the first to the second embodiments can be provided.

The configuration of this mobile phone is the same as that shown in FIG. 1.

The operation of the mobile phone is the same as that shown in FIG. 13 and FIG. 14.

Due to such a configuration, the mobile phone can divide, block, attach a clock and mix an image data even though it has a large capacity, and sends it in one circuit. As a result, high-speed transmission can be realized.

### Embodiment of the Transmitter and the Receiver

### (I) Transmitter and Receiver

Next, embodiments of the transmitter and the receiver will be explained.

In the aforementioned embodiment of the communication apparatus, an explanation was made on a communication apparatus in which one communication apparatus is provided with both transmitting function and receiving function. Both transmitting and receiving functions are not necessarily provided. The transmitter or the receiver may be one which has only one of these functions.

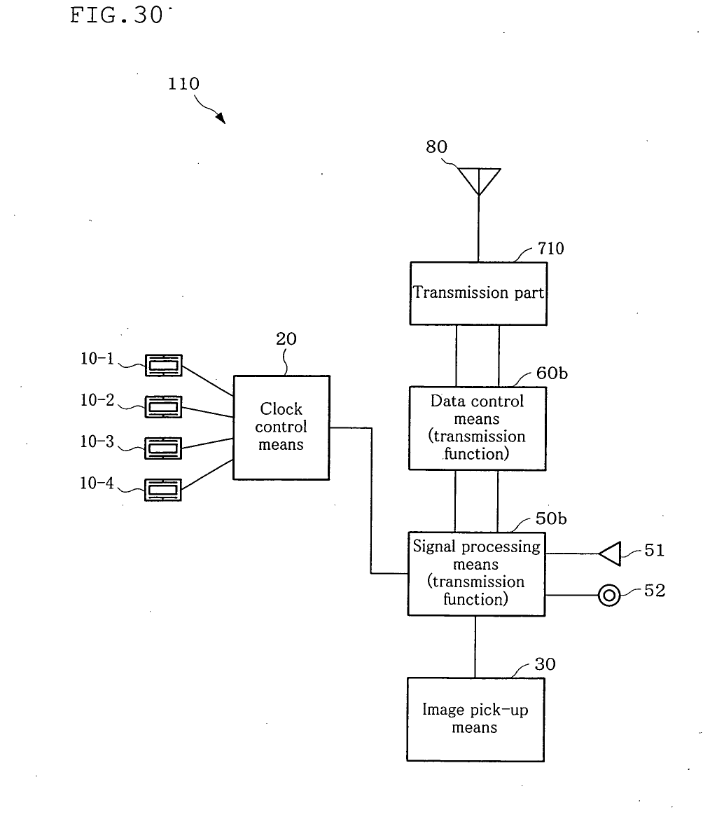

That is, the transmitter or the receiver in this embodiment has part of the communication apparatus in each of the embodiments mentioned above. Therefore, in FIGS. 30 to 33, the same constituting elements as those in FIG. 1 are indicated by the same numerals, and a detailed explanation thereof is omitted.

For example, as shown in FIG. 30, the transmitter 110 is provided with the crystal oscillator 10 (10-1 to 10-n), the clock control means 20, the image pick-up means 30, the signal control means (transmitting means) 50b, the data control means (transmitting function) 60b, the transmitting part 710 and the antenna 80.

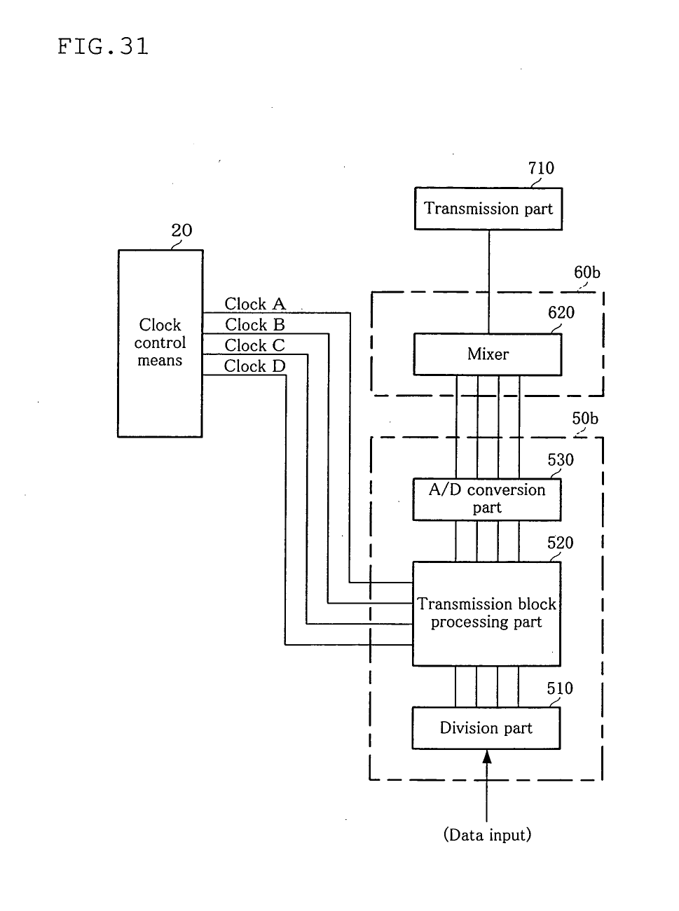

As shown in FIG. 31, the signal processing means 50b is provided with the division part 510, the transmission block processing part 520 and the ND conversion part 530.

The data control means 60b is provided with the mixer 620. This data control means 60b may be provided with the transmission signal correction part 610.

The operation of this transmitter 110 (transmission method) is the same as the processing procedure shown in FIG. 13.

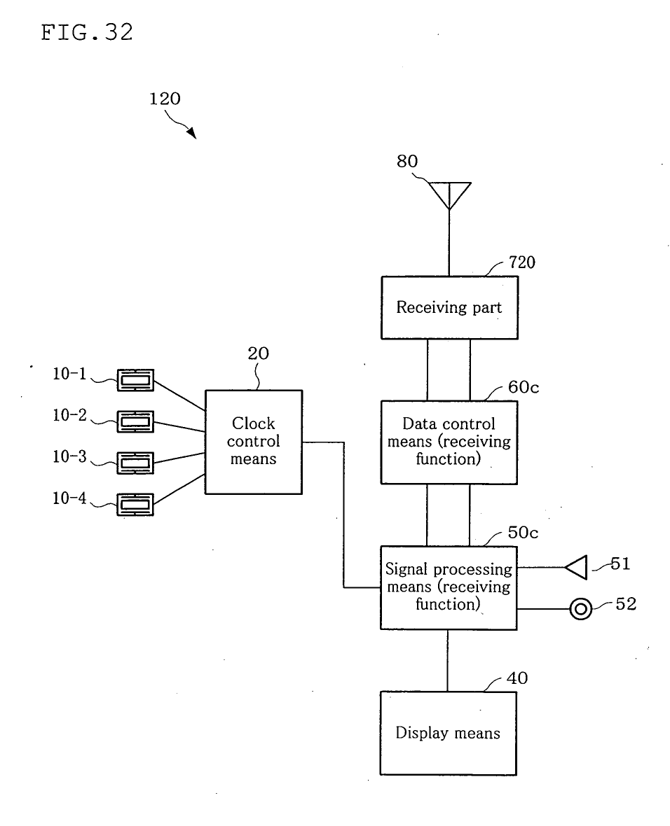

Further, as shown in FIG. 32, the receiver 120 is provided with the crystal oscillator 10 (10-1 to 10-n), the clock control means 20, the display means 40, the signal processing means (receiving function) 50c, the data control means (receiving function) 60c, the receiving part 720 and the antenna 80.

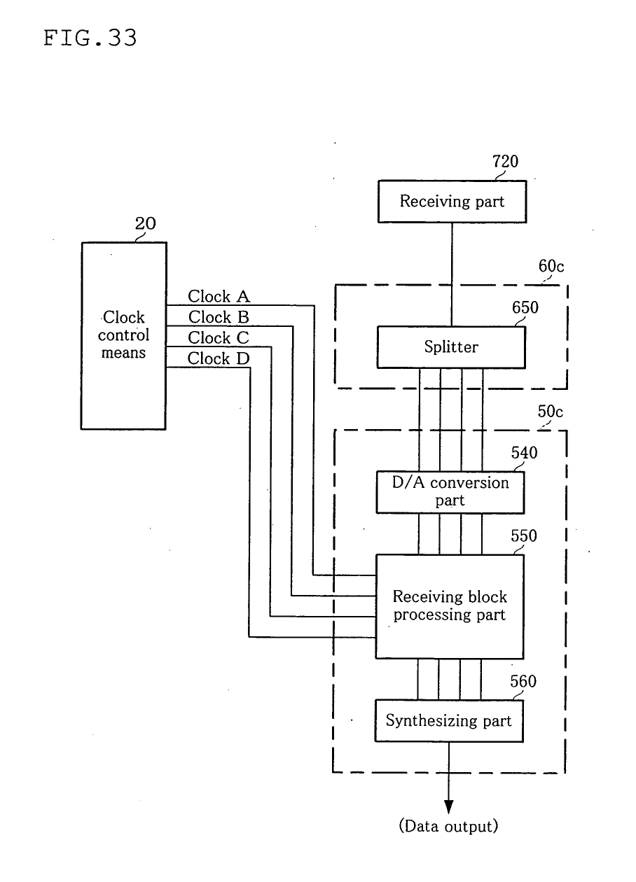

The signal processing means 50c is, as shown in FIG. 33, provided with the D/A conversion part 540, the receiving block processing part 550 and the synthesizing part 560.

The data control means 60c is provided with the splitter 630. This data control means 60c may have the receiving signal correction part 640.

The operation of the receiver 120 is the same as the processing procedure shown in FIG. 14.

Due to such a configuration, the communication apparatus as the transmitter divides the picked-up image data, and allows one of the thus divided data to have a transmittable data amount, whereby compression can be omitted. As a result, high-speed transmission of picked-up image data becomes possible.

On the other hand, the communication apparatus as the receiver can synthesize the block data based on the frequency of the clock and display on the screen an image based on the picked-up image data. As a result, since decompression becomes no longer necessary, high-speed display of an image becomes possible and deterioration of an image can be prevented.

### First Embodiment of the Communication System

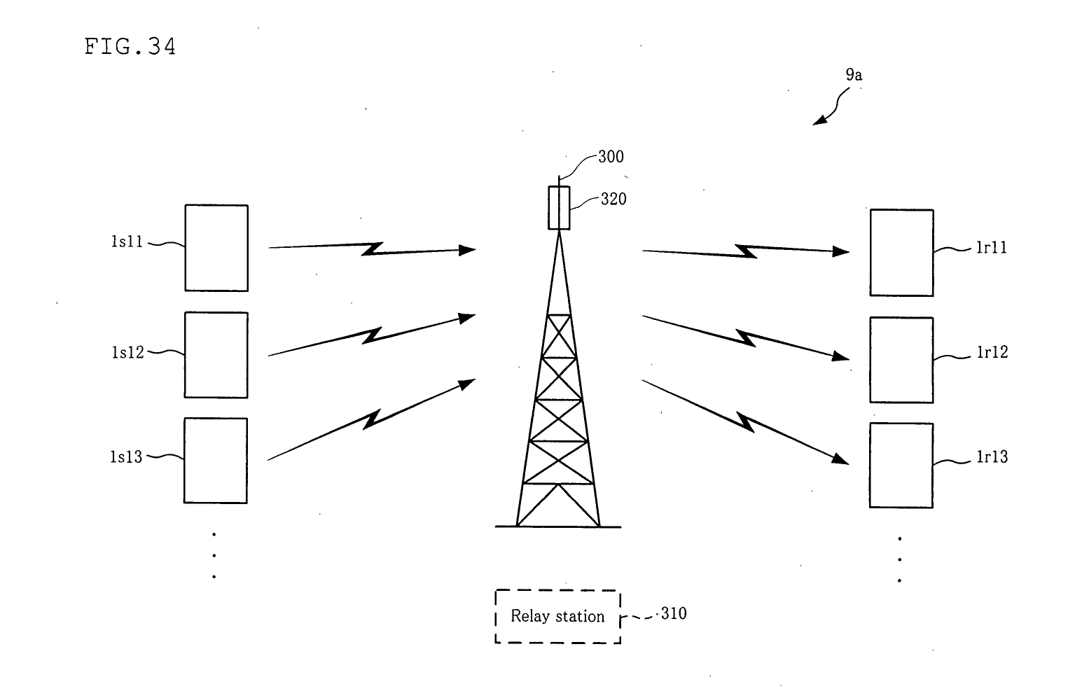

The first embodiment of the communication system will be explained with reference to FIG. 34.

FIG. 34 is a view showing the configuration of the communication system of this embodiment.

As shown in FIG. 34, the communication system 9a of this embodiment is provided with communication apparatuses (transmission side) 1s1 (1s11 to 1s1n), communication apparatuses (receiving side) 1r1 (1r1 to 1r1n), a relay apparatus 310 of a base station 300.

The communication apparatus (transmission side) 1s1 transmits an electric wave (transmission signals) to the communication apparatus 1r1 (receiving side) through the base station 300.

For one base station 300, one or two or more communication apparatuses (transmission side) 1s1 can be communicated.

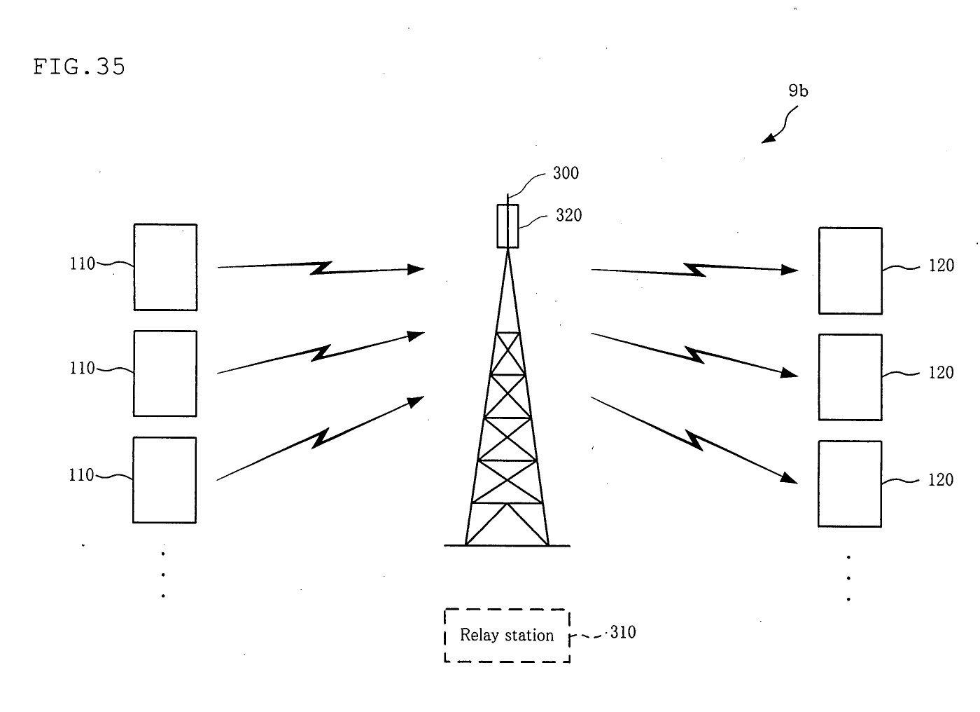

Each of the one or two or more communication apparatuses (transmission side) 1s1 is composed of one of the communication apparatuses 1a and 1b of the above-mentioned first, second and fifth embodiments. That is, the communication apparatus (transmission side) 1s1 divides video image data as analogue data according to the carrier width of the communication line, subjects the thus divided data to blocking, attaches a clock to the block data, digitally encoding the data, whereby the carrier is modulated to allow the data to be transmitted. Meanwhile, as shown in FIG. 35, instead of the communication apparatus (transmission side) 1s1, the transmitter 110 may be used.

The communication apparatus (receiving side) 1r1 receives an electric wave which has been transmitted from the communication apparatus (transmission side) 1s1 through the base station 300.

For one base station 300, one or two or more communication apparatuses (receiving side) 1r1 can be communicated.

Each of the one or two or more communication apparatuses (receiving side) 1r1 is composed of one of the communication apparatuses 1a and 1b of the above-mentioned first, second and fifth embodiments. That is, the communication apparatus (receiving side) 1r1 demodulates an electric wave, converts it to an analogue electric wave, divides it into block data and clocks, synthesizes the block data, and displays it as video image data. Instead of the communication apparatus (receiving side) 1r1, the receiver 120 can be used as shown in FIG. 35.

The base station 300 means a whole set of an apparatus, annexed buildings, and the location where the base station is present which are used for conducting wireless communication between the communication apparatus (transmitting side) 1s1 and the communication apparatus (receiving side) 1r1.

The relay apparatus 310 can be provided in the base station 300. It receives an electric wave received by an antenna 320 of the base station 300, and the electric wave is sent to the telephone network (not shown). Further, it transmits an electric wave from the telephone network through an antenna 320.

In this embodiment, the relay apparatus 310 is provided in the base station 300. Location of the relay apparatus 310 is not limited to the base station 300. For example, in a place where no base station 300 is provided, it can be provided as an apparatus which relays the communication apparatus (transmitting side) 1s1 and the communication apparatus (receiving side) 1r1. Further, the relay apparatus 310 can be provided as an apparatus which relays the base station 300 and the communication apparatuses 1s1 and 1r1.

Further, the transmission procedure by the communication apparatus (transmission side) 1s1 is the same as the processing procedure shown in FIG. 13. The receiving procedure by the communication apparatus (receiving side) 1r1 is the same as the processing procedure shown in FIG. 14.

As explained hereinabove, according to the communication system of this embodiment, the communication apparatus on the transmission side divides video image data according to the carrier width of the transmission path, and transmits the thus divided data as a plurality of block data, and the communication apparatus on the receiving side synthesizes the plurality of block data and displays the thus synthesized data, compression or decompression processing becomes no longer necessary, whereby the time required for compression can be saved and the transmission time can be shortened. As a result, transmission and receiving of image data between communication apparatuses can be conducted at a high speed.

### Second Embodiment of the Communication System

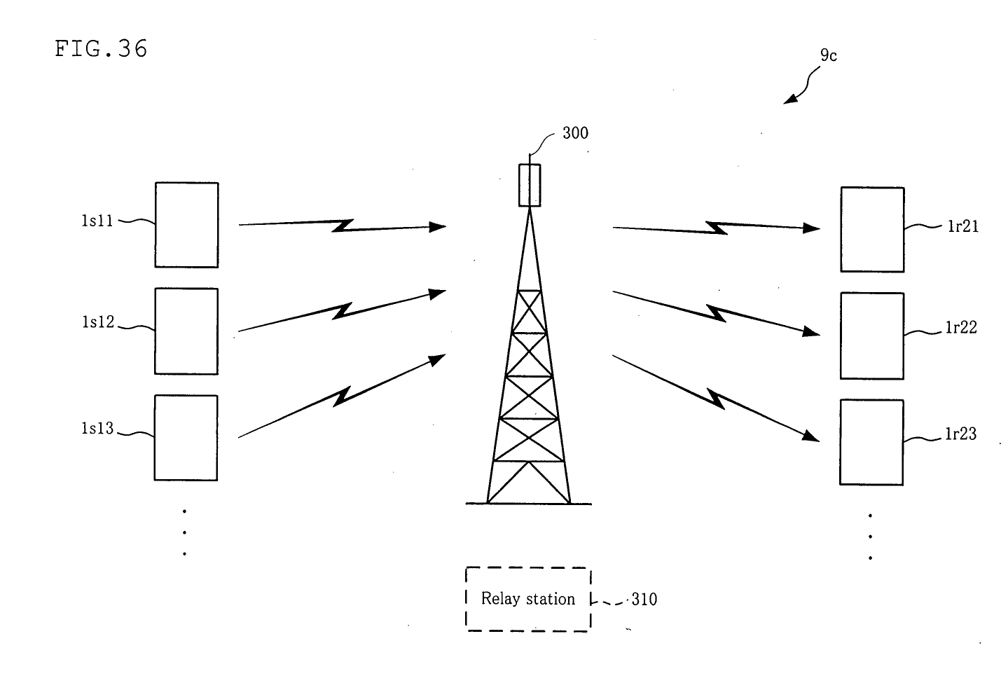

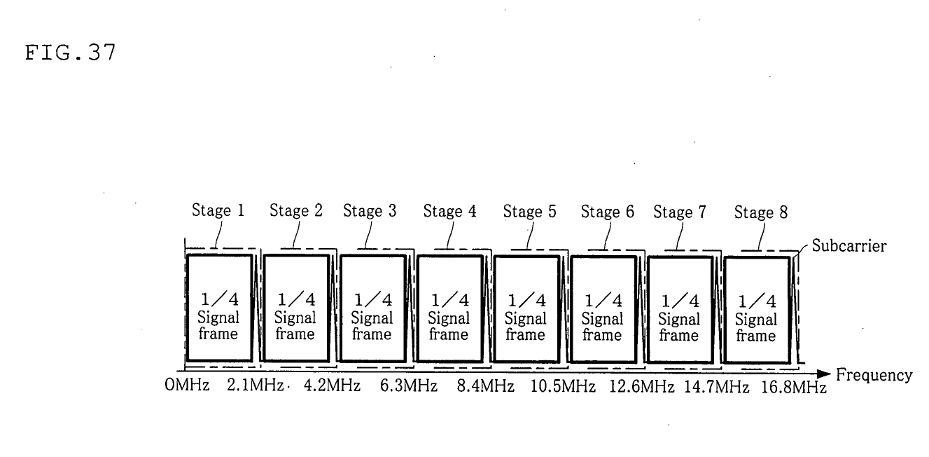

Next, the second embodiment of the communication system will be explained with reference to FIG. 36 and FIG. 37.

FIG. 36 is a view showing the configuration of the communication system of this embodiment. FIG. 37 is a block diagram showing the configuration of the relay apparatus provided in the communication apparatus.

The communication system of this embodiment differs from the communication system of the first embodiment in that the communication apparatus 1r2 on the receiving side does not have a function of synthesizing analogue data. Other constituting elements are the same as those in the first embodiment.

Therefore, in FIG. 36, the same constituting elements as those in FIG. 34 are indicated by the same numerals, and a detailed explanation thereof is omitted.

As shown in FIG. 36, the communication system 9c of this embodiment is provided with communication apparatuses on the transmission side 1s1 (1s11 to 1s1n) and communication apparatuses on the receiving side 1r2 (1r21 to 1r2n), and the relay apparatus 310 of the base station 300.

The communication apparatus (on the transmission side) 1s1 sends an electric wave (transmission signals) to the communication apparatus (on the receiving side) 1r1 through the base station 300. For one base station 300, one or two or more communication apparatuses (transmission side) 1s1 can be communicated.

Each of the one or two or more communication apparatuses (transmission side) 1s1 is composed of one of the communication apparatuses 1a and 1b of the above-mentioned first, second and fifth embodiments. That is, the communication apparatus (transmission side) 1s1 divides video image data as analogue data according to the carrier width of the communication line, subjects the divided data to blocking, attaches a clock, digitally encodes them, whereby the carrier is modulated to allow the data to be transmitted. Meanwhile, instead of the communication apparatus (transmission side) 1s1, the transmitter 110 may be used.

The communication apparatus (receiving side) 1r2 receives an electric wave (transmission signals) which has been transmitted from the communication apparatus (transmission side) 1s1 through the base station 300. For one base station 300, one or two or more communication apparatuses (transmission side) 1r2 can be communicated.

Unlike the communication apparatuses 1a and 1b and the receiver 1d in the above-mentioned first, second and fifth embodiments, each of the one or two or more communication apparatuses (receiving side) 1r2 has only one crystal oscillator 10. Therefore, it cannot judge that any of the clocks A to D is a clock contained in the analogue data.

However, the communication apparatus (receiving side) 1r2 conducts a processing such as demodulation, splitting and D/A conversion when it receives transmission signals which have been transmitted from the communication apparatus 1s1. Then, the communication apparatus (receiving side) 1r2 detects only the clock A from the analogue data, and does not detect the clocks B to D. In this case, the communication apparatus (receiving side) 1r2 discards the clocks B to D, and synthesizes the image of each region based on the plurality of block data in the order of receiving, whereby the synthesized image is displayed on the screen.

Due to such a configuration, if the communication apparatus on the transmission side is the communication apparatus of the first embodiment or the like and the communication apparatus on the receiving side is not the communication apparatus of the first embodiment or the like, when the communication apparatus on the receiving side has a function of synthesizing a plurality of analogue data, the received picked-up image data can be displayed on the screen.

In this case, since no compression is conducted by the communication apparatus on the transmission side and no decompression is conducted by the communication apparatus on the receiving side, high-speed transmission becomes possible and deterioration of image quality can be prevented.

Hereinabove, the preferred embodiments of the transmitter, the receiver, the communication apparatus, the communication system, the transmission method and the receiving method of the present invention are explained. However, the transmitter, the receiver, the communication apparatus, the communication system, the transmission method and the receiving method of the present invention are not limited to the embodiments as mentioned above, and it is needless to say that various modifications are possible within the scope of the present invention.

For example, in the above-mentioned embodiments, the web tuner and the mobile phone are given as examples of an apparatus provided with the communication apparatus. An apparatus provided with the communication apparatus is not limited to a web tuner or a mobile phone, and any apparatus or appliance which transmits and receives images by wireless or wired communication can be provided with the communication apparatus.

Further, in FIG. 6 and FIG. 7, a configuration in which four stages are provided is shown. The number of stages is, however, not limited to four, and as shown in FIG. 37, for example, eight or more stages can be provided. In this case, the crystal oscillator 10 is provided in a number equal to the number of the stage. Clocks are generated in a number equal to the number of stages. Each clock has a frequency of integral multiple of 2.1 MHz (2.1 MHz to 16.8 MHz). One image is divided into regions of which the number is equal to the number of stages. Picked-up image data can be divided into a number equal to the number of stages. The divided data is sequentially put in the signal frame of each stage.

### INDUSTRIAL APPLICABILITY

The characteristic feature of the present invention resides in the configuration of data to be transmitted and received. Therefore, the present invention can be used in an apparatus or an appliance which transmits and receives data.

1. A transmitter comprising:
a clock control means which outputs a plurality of clocks which have different frequencies;
a division means which divides analogue data into a prescribed number;
a clock attachment means which attaches a clock of a different frequency to each of the divided analogue data;
a digital converting means which converts the analogue data to digital data, thereby to generate a plurality of digital signals; and
a transmission means which transmits to the outside the plurality of digital signals as transmission signals.

2. The transmitter according to claim 1, wherein each of the divided analogue data is referred to as divided data, and the clock attachment means divides each of the divided data according to a prescribed data amount, thereby to generate a plurality of block data, and attaches a clock of the same frequency to each of the plurality of block data divided from one divided data.

3. The transmitter according to claim 2, wherein, when the transmission signal is transferred to other apparatuses through a radio or cable transmission path, each of the block data has a prescribed data amount which can be transmitted by the transmission path.

4. The transmitter according to claim 2, wherein the division means divides the analogue data in correspondence with each region which is formed when the division means divides one image generated by the analogue data into a plurality of regions, and
the clock attachment means sets a stage for each of the regions, provides a signal frame for each of these stages, puts the block data in these signal frames, allows a clock of a different frequency to correspond to each of the stages, and attaches the block data the clock corresponding to the stage.

5. The transmitter according to claim 1, wherein the plurality of clocks has different frequencies which are multiple integral of a prescribed frequency.

6. The transmitter according to claim 5, wherein the frequency range of the stage is 0 Hz to multiple integral of 2.4 MHz, and
the frequency which is multiple integral of 2.4 MHz is set by the clock.

7. The transmitter according to claim 1, wherein it provides with a plurality of crystal oscillators which output a clock and send the clock to the clock control means, and
the plurality of crystal oscillators output clocks of different frequencies.

8. The transmitter according to claim 7, wherein the clock control means receives a clock from the plurality of crystal oscillators, and selects and outputs one or two or more clocks according to the type of the analogue data.

9. A receiver comprising:
a receiving means which receives signals from the outside;
a splitter which splits the signals into a plurality of digital signals;
an analogue converting means which converts the plurality of digital signals to analogue signals and separates the signals into a plurality of analogue data and clocks; and
a synthesizing means which synthesizes the plurality of analogue data according to the frequency of the clock.

10. The receiver according to claim 9, wherein the synthesizing means determines the order of synthesizing the analogue data according to the frequency of the clock.

11. A communication apparatus comprising:
a clock control means which outputs a plurality of clocks which have different frequencies;
a division means which divides analogue data into a prescribed number;
a clock attachment means which attaches a clock of a different frequency to each of the divided analogue data;
a digital converting means which converts the analogue data to which the clock has been attached to digital data, thereby to generate a plurality of digital signals;
a transmission means which transmits to the outside the plurality of digital signals as transmission signals;
a receiving means which receives signals from the outside;
a splitter which splits the signals into a plurality of digital signals;
an analogue converting means which converts the plurality of digital signals to analogue signals to separate the signals into a plurality of analogue data and clocks; and
a synthesizing means which synthesizes the plurality of analogue data according to the frequency of the clock.

12. The communication apparatus according to claim 11 wherein the communication apparatus comprises a mobile phone.

13. The communication apparatus according to claim 11 wherein the communication apparatus comprises a web tuner.

14. A communication system comprising one or two or more transmitters and one or two or more receivers, wherein
the transmitters comprise the transmitter according to claim 1, and
the receivers comprise a receiver comprising
a receiving means which receives signals from the outside;
a splitter which splits the signals into a plurality of digital signals;
an analogue converting means which converts the plurality of digital signals to analogue signals and separates the signals into a plurality of analogue data and clocks; and
a synthesizing means which synthesizes the plurality of analogue data according to the frequency of the clock.

15. A communication system according to claim 14, which further comprises a base station which relays signals which are transmitted and received between the transmitter and the receiver.

16. A communication system which comprises a plurality of communication apparatuses and a base station which relays signals which are transmitted and received between the communication apparatuses, wherein the communication apparatuses comprise the communication apparatus according to claim 11.

17. A communication system which comprises a web tuner which receives video image communication signals which have been transmitted from a video image distribution apparatus through a communication line and outputs video image signals, and a display apparatus which displays a video image based on the video image signals, wherein the web tuner comprises the communication apparatus according to claim 13.

18. The communication system according to claim 17 which comprises a image-pick up apparatus which takes a video image, wherein the video image distribution apparatus receives signals of the picked-up video image which has been transmitted from the image-pick up apparatus, and transmits through the communication line the picked-up video image signals to a web tuner as the video image communication signals.

19. A communication system comprising:
a camera apparatus which takes an image of an object to be photographed;
a first web tuner which receives picked-up image signals based on the image taken by the camera apparatus;
a video image distribution apparatus which receives the picked-up image signals from the first web tuner and transmits the signals to a second web tuner through a communication line; and
a display apparatus which inputs the picked-up image signals through the second web tuner and displays a video image based on the picked-up image signals, wherein
the first and/or the second web tuner comprises the communication apparatus according to claim 13.

20. A transmission method comprising:
outputting a plurality of clocks which have different frequencies;
dividing analogue data into a prescribed number;
attaching a clock of a different frequency to each of the divided analogue data;
converting the analogue data to which the clock has been attached to digital data, thereby to generate a plurality of digital signals; and
transmitting the plurality of digital signals to the outside as transmission signals.

21. The transmission method according to claim 20, which further comprises referring each of the divided analogue data to as divided data, and dividing each of the divided data according to a prescribed data amount, thereby to generate a plurality of block data, and attaching a clock of the same frequency to each of the plurality of block data classified from one divided data.

22. A receiving method comprising:
receiving signals from the outside;
splitting the signals into a plurality of digital signals;
converting the plurality of digital signals to analogue signals and dividing the signals into a plurality of analogue data and clocks; and
synthesizing the plurality of analogue data based on the frequency of the clock.

23. The receiving method according to claim 22 which further comprises determining the order of synthesizing the analogue data based on the frequency of the clock.
